(19) United States
(12) Patent Application Publication
(10) Pub. No.: US 2026/0352834 A1
(43) Pub. Date: Nov. 5, 2026

(54) ENCODING METHOD, DECODING METHOD, BITSTREAM, ENCODER, DECODER AND STORAGE MEDIUM

(71) Applicant: GUANGDONG OPPO MOBILE TELECOMMUNICATIONS CORP., LTD., Dongguan (CN)

(72) Inventor: Nan SONG, Dongguan (CN)

(21) Appl. No.: 19/723,330

(22) Filed: Jun. 29, 2026

Related U.S. Application Data
(63) Continuation of application No. PCT/CN2024/070381, filed on Jan. 3, 2024.

(51) Int. Cl. H04N 19/136; H04N 19/172; H04N 19/186; H04N 19/70

(52) U.S. Cl. CPC H04N 19/136; H04N 19/172; H04N 19/186; H04N 19/70

(57) ABSTRACT

An encoding method, a decoding method, a bitstream, an encoder, a decoder and a storage medium are provided. The decoding method includes that: a bitstream is decoded to determine first identification information; in response to determining based on the first identification information that a CCALF is used to perform filtering processing on a current colour component of a current picture, a scale factor and a filtering coefficient corresponding to the current colour component are determined; and based on the scale factor and the filtering coefficient, a reconstructed block of a current block is determined.

### CROSS-REFERENCE TO RELATED APPLICATION

This is a continuation application of International Patent Application No. PCT/CN2024/070381, filed on Jan. 3, 2024, the content of which is hereby incorporated by reference in its entirety.

### BACKGROUND

Cross Component Adaptive Loop Filter (CCALF) is a filter designed to minimize the mean square error between a reconstructed chroma picture and an original picture by using luma information. The cross component adaptive loop filter processes chroma components U and V respectively, and each component has its own filter.

In order to solve the problem of large encoding and decoding bit overhead caused by floating-point filter coefficients, a scale factor is introduced to perform integerization process on the filter coefficients.

However, during the application of the scale factor in conventional technologies, there are problems of either poor flexibility or large bit overhead, which cannot achieve an ideal filtering effect, thereby reducing the coding performance.

### SUMMARY

Embodiments of the present disclosure relate to the technical field of image processing, and in particular, to an encoding method, a decoding method, a bitstream, an encoder, a decoder, and a storage medium.

Technical solutions of the embodiments of the present disclosure may be implemented as follows.

In a first aspect, an embodiment of the present disclosure provides a decoding method applied to a decoder, the method includes that:
a bitstream is decoded to determine first identification information;
in response to determining based on the first identification information that CCALF is used to perform filtering processing on a current colour component of a current picture, a scale factor and filter coefficients corresponding to the current colour component are determined; and
a reconstructed block of a current block is determined based on the scale factor and the filter coefficients.

In a second aspect, an embodiment of the present disclosure provides an encoding method applied to an encoder, the method includes that:
a scale factor corresponding to a current colour component of a current picture is determined; and
first identification information is determined based on a rate-distortion cost corresponding to the scale factor, and the first identification information is signalled into a bitstream; herein, the first identification information is used to indicate whether CCALF is used to perform filtering processing on the current colour component of the current picture.

In a third aspect, an embodiment of the present disclosure provides a decoder, and the decoder includes a processor and a memory configured to store a computer program executable on the processor. When executing the computer program, the processor is configured to:

decode a bitstream to determine first identification information; in response to determining based on the first identification information that CCALF is used to perform filtering processing on a current colour component of a current picture, determine a scale factor and filter coefficients corresponding to the current colour component; and determine a reconstructed block of a current block based on the scale factor and the filter coefficients.

### BRIEF DESCRIPTION OF THE DRAWINGS

FIG. 1 is a schematic diagram of the application of an encoding framework provided by the related art.

FIG. 2 is a schematic diagram of a shape of a conventional CCALF filter.

FIG. 3 is a schematic diagram of a shape of a conventional CCALF filter.

FIG. 4 is a schematic block diagram of a component of a video encoding system according to an embodiment of the present disclosure.

FIG. 5 is a schematic block diagram of a component of a video decoding system according to an embodiment of the present disclosure.

FIG. 6 is a schematic diagram of a decoding method according to an embodiment of the present disclosure.

FIG. 7 is a first test result of a decoding method according to an embodiment of the present disclosure.

FIG. 8 is a second test result of the decoding method according to the embodiment of the present disclosure;

FIG. 9 is a schematic diagram of an encoding method according to an embodiment of the present disclosure;

FIG. 10 is a schematic diagram of the composition structure of an encoder according to an embodiment of the present disclosure;

FIG. 11 is a schematic diagram of a specific hardware structure of an encoder according to an embodiment of the present disclosure;

FIG. 12 is a schematic diagram of a composition structure of a decoder according to an embodiment of the present disclosure;

FIG. 13 is a schematic diagram of a specific hardware structure of a decoder according to an embodiment of the present disclosure;

FIG. 14 is a schematic diagram of a composition structure of an encoding and decoding system according to an embodiment of the present disclosure.

### DETAILED DESCRIPTION

The technical solutions in the embodiments of the present disclosure will be clearly and completely described below with reference to the accompanying drawings in the embodiments of the present disclosure. It should be understood that the specific embodiments described herein are merely used to explain the present disclosure, rather than to limit the present disclosure. In addition, it should be noted that, for convenience of description, the accompanying drawings only show parts related to the present disclosure.

In the following description, reference is made to “some embodiments”, which describes a subset of all possible embodiments, but it should be understood that “some embodiments” may be the same subset or different subsets of all possible embodiments, and may be combined with each other without conflict. It should be pointed out that the terms “first\second\third” involved in the embodiments of the present disclosure are used to distinguish similar objects, and do not represent a specific order of the objects. It may be understood that “first\second\third” may be interchanged in a specific order or a priority order where permitted, so that the embodiments of the present disclosure described herein may be implemented in an order other than that illustrated or described herein.

Digital video compression technology mainly compresses massive digital video data to facilitate transmission and storage. With the surge of internet video and people's increasing demand for higher video definition, although existing digital video compression standards can save a lot of video data, there is still a need to pursue better digital video compression technology to reduce the bandwidth and traffic pressure of digital video transmission.

In the digital video encoding process, an encoder reads unequal samples of an original video sequence in different colour formats, including a luma component and chroma components, i.e., the encoder reads a black-and-white or colour picture. The picture is then partitioned into blocks, and the block data is sent to the encoder for encoding.

General video encoding and decoding standards are based on a block-based hybrid coding framework. Each of video pictures is partitioned into square Largest Coding Units (LCUs) or Coding Tree Units (CTUs) of the same size (such as 128×128, 64×64, etc.). Each LCU or CTU may be further partitioned into rectangular Coding Units (CUs) according to rules. Moreover, a coding unit may be further partitioned into smaller Prediction Units (PUs), Transform Units (TUs), and so on.

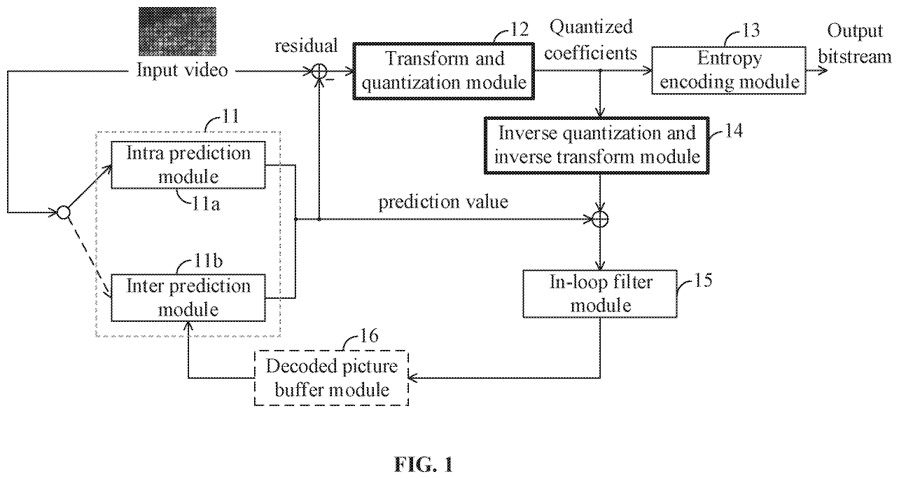

FIG. 1 is a schematic diagram of the application of an encoding framework provided by the related art. As shown in FIG. 1, the hybrid encoding framework may include a prediction module 11, a transform and quantization module 12, an entropy encoding module 13, an inverse quantization and inverse transform module 14, an in-loop filter module 15, and a decoded picture buffer module 16. Herein, the prediction module 11 may include an intra prediction module 11a and an inter prediction module 11b. The inter prediction module 11b may include a motion estimation module and a motion compensation module. Since there is a strong correlation between adjacent samples within a picture of video pictures, using intra prediction mode in video encoding and decoding technology can eliminate spatial redundancy between adjacent samples. However, since there is also a strong similarity between adjacent pictures of video pictures, using inter prediction mode in video encoding and decoding technology can eliminate temporal redundancy between adjacent pictures, thereby improving encoding and decoding efficiency. The basic process of a video encoder/decoder is as follows. At the encoding side, one picture is partitioned into blocks; intra prediction or inter prediction is performed on a current block to generate a prediction block for the current block; a residual block is obtained by subtracting the prediction block from an original block of the current block; transform and quantization are performed on the residual block to obtain a quantized coefficient matrix; and entropy encoding is performed on the quantized coefficient matrix, and a bitstream is output. At the decoding side, intra prediction or inter prediction is performed on the current block to generate a prediction block for the current block; on the other hand, the bitstream is decoded to obtain a quantized coefficient matrix; inverse quantization and inverse transform are performed on the quantized coefficient matrix to obtain a residual block, and a reconstructed block is obtained by adding the prediction block and the residual block. Reconstructed blocks form a reconstructed picture, and loop filtering is performed on the reconstructed image on an image basis or a block basis to obtain a decoded picture. The encoding side also needs to perform operations similar to those on the decoding side to obtain a decoded picture. The decoded picture may serve as a reference picture for inter prediction of subsequent pictures. The block partitioning information, mode information or parameter information (such as prediction, transform, quantization, entropy encoding, and in-loop filtering) determined by the encoding side, if necessary, needs to be signalled into the bitstream. The decoding side parses and analyzes the existing information to determine the same block partitioning information, mode information or parameter information (such as prediction, transform, quantization, entropy encoding, and in-loop filtering) as the encoding side, thereby ensuring that the decoded picture obtained by the encoding side is the same as the decoded picture obtained by the decoding side. The decoded picture obtained by the encoding side is also generally referred to as a reconstructed picture. During prediction, the current block may be partitioned into prediction units; and during transform, the current block may be partitioned into transform units. The partitioning of prediction units and transform units may be different. The above describes the basic process of a video encoder/decoder under the block-based hybrid coding framework. With the development of technology, some modules or steps of this framework or process may be optimized. The embodiments of the present disclosure are applicable to, but not limited to, the basic process of a video encoder/decoder under the block-based hybrid coding framework.

It may be understood that intra prediction only references information from the same picture to predict sample information within the current partitioned block, which is used to eliminate spatial redundancy. Inter prediction may reference picture information from different pictures, and uses motion estimation to search for motion vector information that best matches the current partitioned block, which is used to eliminate temporal redundancy. Transform converts the predicted picture block into the frequency domain, redistributing energy; and combined with quantization, information insensitive to the human eye can be removed, which is used to eliminate visual redundancy. Entropy encoding can eliminate character redundancy based on the current context model and probability information of the binary bitstream. In-loop filtering mainly processes samples after inverse transform and inverse quantization, to compensate for distortion information and provide better references for subsequent encoding of samples.

In Versatile Video Coding (VVC), the in-loop filter mainly includes luma mapping with chroma scaling, a Deblocking Filter (DBF), Sample Adaptive Offset (SAO), an Adaptive Loop Filter (ALF), and a Cross Component Adaptive Loop Filter (CCALF). The Cross Component Adaptive Loop Filter (CCALF) is a filter designed to minimize the mean square error between a reconstructed chroma picture and an original picture by utilizing luma information.

In a VVC encoder, the cross component adaptive loop filter processes the chroma components U and V separately, with each component having its own filter. Each component allows to use at most 4 filters, corresponding to 4 categories respectively. CCALF classifies each CTU, and all samples within a CTU belong to the same category. The covariance matrices and error vectors of samples belonging to the same category are accumulated respectively, and then Wiener-Hopf equations are constructed. The filter coefficients for that category are calculated by solving the equations. Each CTU selects the filter corresponding to its category for filtering, and the filtered result is written into the reconstructed picture. In addition, the filter coefficients need to be written into an Adaptive Parameter Set (APS), and the corresponding syntax elements are signalled into the bitstream through entropy encoding.

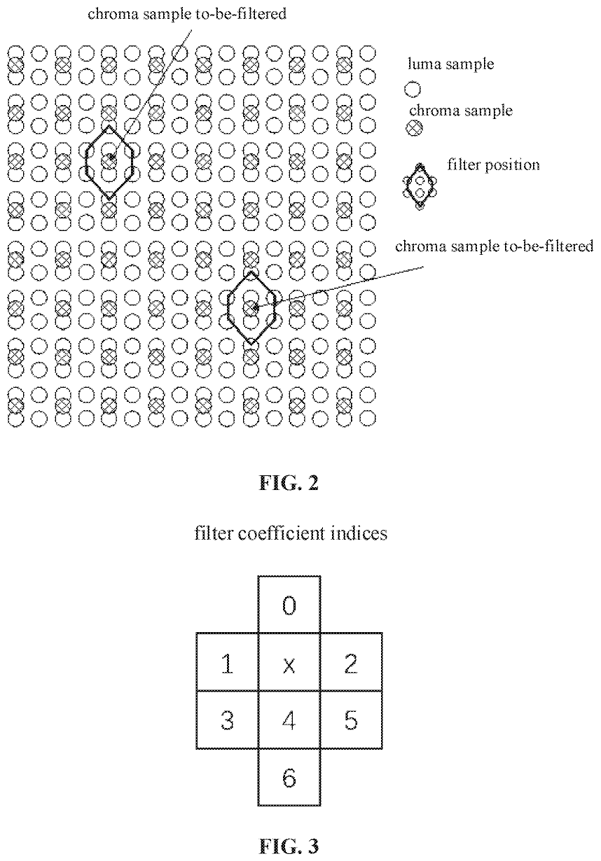

FIG. 2 is a schematic diagram of the shape of a conventional CCALF filter. As shown in FIG. 2, in VVC, CCALF utilizes adjacent luma information to minimize the mean square error between a reconstructed chroma picture and an original picture. Solid circles represent luma samples, and grid-patterned circles represent chroma samples. The chroma sample at the center of the black-box region is the chroma sample to-be-filtered, and the luma samples within the region need to be input into the filter. It may be seen that there are 8 luma samples within the box, which correspond to 8 filter coefficients respectively based on their positions in the filter.

FIG. 3 is a schematic diagram of filter coefficients. Herein, 0, 1, 2, 3, 4, 5, 6, x in FIG. 3 represent filter coefficient indices. It should be noted that the coefficient at position x is generally not calculated and defaults to 0.

In a VVC encoder, CCALF classifies CTUs, and this classification process is decided by using a Rate-Distortion Optimization (RDO) function. Every sample within a CTU belongs to the same category. Specifically, when the cost calculated for a CTU using a certain category of filter is the minimum, the category of this CTU is the category of this filter. Of course, if the cost without filtering is less than the cost by using a filter, the CTU is not filtered. In this case, the CTU has no category. Whether the CTU is filtered and the corresponding category information are both signalled into the bitstream and transmitted to the decoding side.

After the category of each CTU is determined, the covariance matrices and error vectors of all samples belonging to the same category are accumulated respectively. Specifically, for each sample, its covariance matrix A is a 7×7 square matrix. Each element of matrix A is denoted as a_{i,j}, where i, j∈[0,1,2,3,4,5,6], and for a_{i, j}, its value is:

a_{i,j}=R(i)×R(j) (1)

the value of R(i) is:

R(i)=recY(i)−recY(x) (2)

Herein, recY (*) represents a reconstructed luma sample output by a previous-stage module, x corresponds to the position of x in the filter shape, and i is a sample at a non-x position.

For the error vector B, it is a 7×1 vector. Each element in the vector B is denoted as bᵢ, where i∈[0,1,2,3,4,5,6], for bᵢ, the value is:

bᵢ=R(i)×E (3)

The definition of R(i) is consistent with the above, and for E, there is:

E=orgC−recC (4)

Herein, recC is the reconstructed sample value of the sample to-be-filtered, and orgC represents the original sample value of the sample to-be-filtered.

After obtaining the covariance matrix A and error vector B for each sample, the covariance matrices and error vectors of samples belonging to the same category within a picture are summed respectively. The Wiener-Hopf equation Ac=B is constructed, where A is the sum of the covariance matrices of samples of the same category, and B is the sum of the error vectors of samples of the same category. The coefficient c of this category needs to be solved, where c is a vector of 7×1.

It should be noted that the filter coefficients solved from the equation are all floating-point type. Since the value range of floating-point numbers is almost unrestricted, many bits are required to encode the coefficients. To solve this problem, the VVC encoder performs integerization on the filter coefficients. First, the filter coefficients are scaled:

$${c}_{i}^{′} = {2}^{s c a l e} \times {c}_{i} \qquad ( 5 )$$

Where cᵢ is a filter coefficient solved from the Wiener-Hopf equation, and scale is the scale factor, which is set to a fied value of 7 in

$${c}_{i}^{′}$$

is the scaled value. After obtaining

$${c}_{i}^{′} ,$$

a table lookup is performed on

$${c}_{i}^{′} ,$$

and the number closest to

$${c}_{i}^{′}$$

is selected from {−64, −32, −16, −8, −4, −2, −1, 0, 1, 2, 4, 8, 16, 32, 64} as integerized coefficient

$${c}_{i}^{f}$$

through comparison.

After obtaining the integerized filter coefficient cf, the samples need to be filtered next. The filtering process is as follows:

$${recC}^{′} = recC + ( ( {\sum }_{i} {c}_{i}^{f} \times ( recY ( i ) - recY ( x ) ) + 1 << ( scale - 1 ) ) >> scale ) \qquad ( 6 )$$

Where recC′ is the filtered coefficient. The meanings of values such as recC,

$${c}_{i}^{f}$$

recY (i), recY (x), scale, etc., have been described above and will not be repeated here. After filtering samples that need to be filtered, it is written into the reconstructed picture. For samples that do not need to be filtered, it is directly written into the reconstructed picture.

In addition, relevant syntax elements need to be signalled into the bitstream. For example, the CCALF on/off flag for the current picture, whether each CTU is filtered, and the corresponding category information, etc. If a new filter needs to be used, the number of filters and the coefficients of each filter need to be written into the APS. Finally, the APS ID used by that picture is written into the slice header or picture header information.

On the VVC decoding side, after receiving the bitstream, the CCALF on/off flag for the current picture, whether each CTU is filtered, and the corresponding category information, etc., are determined. In addition, the APS ID is parsed to select the corresponding APS to determine the filter coefficients. Samples that need to be filtered are filtered and written into the reconstructed picture. Samples that do not need to be filtered are directly written into the reconstructed picture.

In the latest standard VVC and the Enhanced Compression Model (ECM) (which is the reference software test model of the JVET traditional video coding exploration platform), the CCALF coefficients use a fixed scale factor (scale) during integerization, which is unreasonable. Since the texture information of each picture differs, using the same scale factor for pictures with different texture complexities makes it difficult to achieve an ideal filtering effect.

To solve the above problem, a filter category-based precision adaptation scheme is introduced. On the encoding side, after the floating-point coefficients c is solved, adaptive scale factor (scale) selection is performed during coefficient integerization. The scale factor (scale) with the minimum cost is selected as the optimal scale factor for the set of filters through the Rate-Distortion Optimization (RDO) function, and the value of the scale factor and the corresponding filter coefficients are written into the APS and transmitted to the decoding side through entropy encoding. In addition, the selected scale factor is used for filtering during the filtering process.

Correspondingly, at the decoding side, when obtaining the filter coefficients, the scale factor value for the set of filters needs to be obtained simultaneously. Similarly, the selected scale factor is used for filtering during the filtering process.

Compared with a fixed scale factor, the filter category-based precision adaptation scheme adaptively selects a scale factor for each set of filter coefficients, providing better flexibility. However, each set of filters needs to transmit the scale factor to the decoding side, resulting in relatively high bit cost. In addition, in the CCALF algorithm architecture, this scheme makes it difficult to obtain a global optimal solution, and it cannot be guaranteed to achieve optimal results in all cases.

It can be seen that during the application of the scale factor in conventional technologies, there are problems of either poor flexibility or large bit overhead, neither of which can achieve an ideal filtering effect, thereby reducing the coding performance.

In view of the above problems, the embodiments of the present disclosure provide an encoding method, a decoding method, a bitstream, an encoder, a decoder, and a storage medium. At the decoding side, the bitstream is decoded to determine first identification information; in response to determining based on the first identification information that CCALF is used to perform filtering processing on a current colour component of a current picture, filter coefficients and the scale factor corresponding to the current colour component are determined; and the reconstructed block for the current block is determined based on the scale factor and the filter coefficients. At the encoding side, the scale factor corresponding to a current colour component of a current picture is determined; the first identification information is determined based on the rate-distortion cost corresponding to the scale factor, and the first identification information is signalled into the bitstream, herein, the first identification information is used to indicate whether CCALF is used to perform filtering processing on the current colour component of the current picture. That is, in the embodiments of the present disclosure, the encoding side can adaptively determine the corresponding scale factor for the current colour component of the current picture. At the decoding side, in response to determining that CCALF is used to perform filtering processing on the current colour component of the current picture, the scale factor corresponding to the current colour component of the current picture can be used to perform CCALF filtering processing on the current colour component, where each filter of the current colour component uses the same scale factor, thereby achieving a more ideal filtering effect and improving encoding performance.

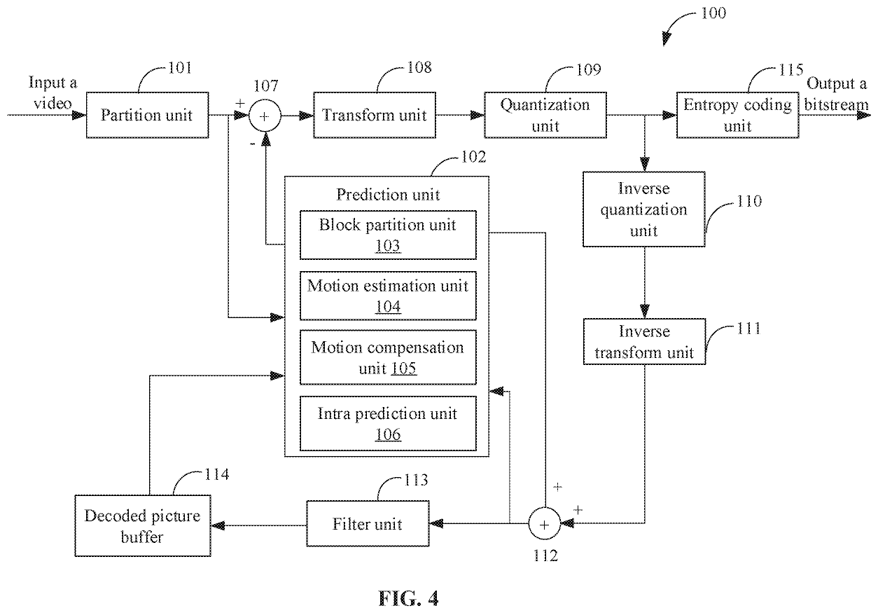

Referring to FIG. 4, which shows an example of a system component block diagram of an encoder provided by an embodiment of the present disclosure. As shown in FIG. 4, the encoder 100 may include: a partition unit 101, a prediction unit 102, a first adder 107, a transform unit 108, a quantization unit 109, an inverse quantization unit 110, an inverse transform unit 111, a second adder 112, a filter unit 113, a decoded picture buffer (DPB) unit 114, and an entropy coding unit 115. Here, the input of the encoder 100 may be a video composed of a series of pictures or a static picture, and the output of the encoder 100 may be a bitstream (also referred to as a “coded bitstream”) representing a compressed version of the input video.

Here, the partition unit 101 partitions a picture in an input video into one or more coding tree units (CTUs). The partition unit 101 partitions the picture into multiple tiles, and may further partition a tile into one or more bricks. The one tile or one brick may include one or more complete and/or partial CTUs. In addition, the partition unit 101 may form one or more slices. One slice may include one or more tiles arranged in raster scan order in the picture or one or more tiles covering a rectangular region in the picture. The partition unit 101 may further form one or more sub-pictures. One sub-picture may include one or more slices, tiles or bricks.

During the encoding process of the encoder 100, the partition unit 101 transfers the CTUs to the prediction unit 102. Typically, the prediction unit 102 may be composed of a block partition unit 103, a motion estimation (ME) unit 104, a motion compensation (MC) unit 105, and an intra prediction unit 106. The block partition unit 103 may further partition the input CTU into smaller Coding Units (CUs) by iteratively using quad-tree partition, binary-tree partition, and ternary-tree partition. The prediction unit 102 may obtain an inter prediction block for the current block by using the ME unit 104 and the MC unit 105. The intra prediction unit 106 may obtain an intra prediction block for the current block by using various intra prediction modes including the MIP mode. In an example, a rate-distortion optimized motion estimation approach may be invoked by the ME unit 104 and the MC unit 105 to obtain the inter prediction block, and a rate-distortion optimized mode determination approach may be invoked by the intra prediction unit 106 to obtain the intra prediction block.

The prediction unit 102 outputs a prediction block for the CU. The first adder 107 calculates a difference (i.e., a residual CU) between the CU in the output of the partition unit 101 and the prediction block for the CU. The transform unit 108 reads the residual CU and performs one or more transform operations on the residual CU to obtain coefficients. The quantization unit 109 quantizes the coefficients and outputs quantized coefficients (i.e., levels). The inverse quantization unit 110 performs a scaling operation on the quantized coefficients to output reconstructed coefficients. The inverse transform unit 111 performs one or more inverse transforms corresponding to the transforms in the transform unit 108 and outputs reconstructed residuals. The second adder 112 calculates a reconstructed CU by adding the reconstructed residual and the prediction block of the CU from the prediction unit 102. The second adder 112 also sends its output to the prediction unit 102 for use as an intra-prediction reference. After all CUs in a picture or sub-picture are reconstructed, the filter unit 113 performs loop filtering on the reconstructed picture or sub-picture. Herein, the filter unit 113 includes one or more filters, such as a deblocking filter, a sample adaptive offset (SAO) filter, an adaptive loop filter (ALF), a luma mapping with chroma scaling (LMCS) filter, and a neural network-based filter, etc. Alternatively, when the filter unit 113 determines that a CU is not used as a reference for encoding other CUs, the filter unit 113 performs loop filtering on one or more target samples in the CU.

The output of the filter unit 113 is a decoded picture or sub-picture, and these decoded pictures or sub-pictures are buffered in the DPB unit 114. The DPB unit 114 outputs decoded pictures or sub-pictures based on timing and control information. Herein, the pictures stored in the DPB unit 114 may also be used as references for the prediction unit 102 to perform inter-prediction or intra-prediction. Finally, the entropy encoding unit 115 converts parameters (such as control parameters and supplementary information, etc.) necessary for decoded pictures from the encoder 100 into binary form, and signals such binary form into the bitstream based on the syntax structure of each data unit, i.e., the encoder 100 finally outputs the bitstream.

Further, the encoder 100 may be a device having a first processor and a first memory storing computer programs. When the first processor reads and executes the computer programs, the encoder 100 reads the input video and generates a corresponding bitstream. In addition, the encoder 100 may also be a computing device having one or more chips. The units implemented as integrated circuits on the chips have connection and data exchange functions similar to those of the corresponding units in FIG. 4.

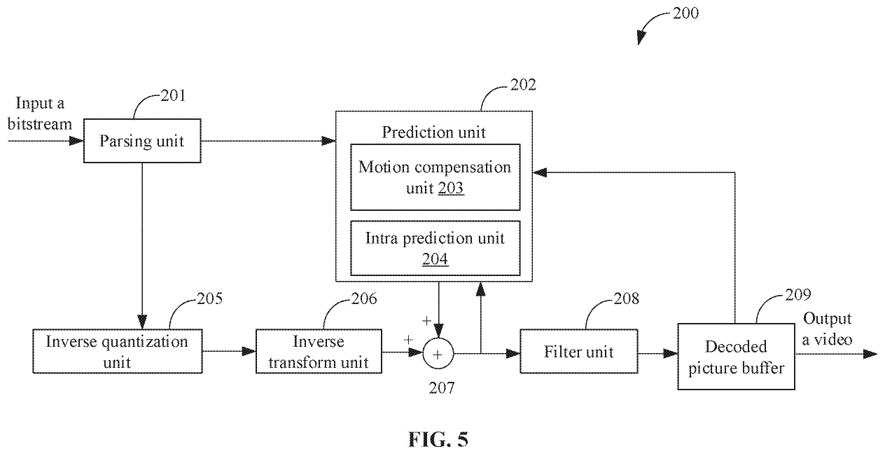

Referring to FIG. 5, which shows an example of a system component block diagram of a decoder provided by the embodiments of the present disclosure. As shown in FIG. 5, the decoder 200 may include: a parsing unit 201, a prediction unit 202, an inverse quantization unit 205, an inverse transform unit 206, an adder 207, a filter unit 208, and a decoded picture buffer unit 209. Herein, the input of the decoder 200 is a bitstream representing a compressed version of a video or a static picture, and the output of the decoder 200 may be a decoded video composed of a series of pictures or a decoded static picture.

The input bitstream of the decoder 200 may be the bitstream generated by the encoder 100. The parsing unit 201 parses the input bitstream and obtains values of syntax elements from the input bitstream. The parsing unit 201 converts the binary representation of syntax elements into numerical values and sends the numerical values to the units in the decoder 200 to obtain one or more decoded pictures. The parsing unit 201 may also parse one or more syntax elements from the input bitstream to display decoded pictures.

During the decoding process of the decoder 200, the parsing unit 201 sends the values of syntax elements, and one or more variables set or determined based on the values of the syntax elements for obtaining one or more decoded pictures, to the units in the decoder 200.

The prediction unit 202 determines a prediction block for a current coding block (e.g., a CU). Herein, the prediction unit 202 may include a motion compensation unit 203 and an intra-prediction unit 204. Specifically, when an inter-decoding mode is indicated for decoding the current coding block, the prediction unit 202 passes relevant parameters from the parsing unit 201 to the motion compensation unit 203 to obtain an inter-prediction block; when an intra-prediction mode (including an MIP mode indicated based on an MIP mode index value) is indicated for decoding the current coding block, the prediction unit 202 passes relevant parameters from the parsing unit 201 to the intra-prediction unit 204 to obtain an intra-prediction block.

The inverse quantization unit 205 has the same function as the inverse quantization unit 110 in the encoder 100. The inverse quantization unit 205 performs a scaling operation on the quantized coefficients (i.e. levels) from the parsing unit 201 to obtain the reconstructed coefficients.

The inverse transform unit 206 has the same function as the inverse transform unit 111 in the encoder 100. The inverse transform unit 206 performs one or more transform operations (i.e., the inverse operation of one or more transform operations performed by the inverse transform unit 111 in the encoder 100) to obtain the reconstruction residual.

The adder 207 performs an addition operation on its inputs (the prediction block from the prediction unit 202 and the reconstructed residual from the inverse transform unit 206) to obtain a reconstructed block for the current coding block. The reconstructed block is also sent to the prediction unit 202 for use as a reference for other blocks encoded in intra-prediction mode.

After all CUs in a picture or sub-picture are reconstructed, the filter unit 208 performs loop filtering on the reconstructed picture or sub-picture. The filter unit 208 includes one or more filters, such as a deblocking filter, a sample adaptive offset filter, an adaptive loop filter, a luma mapping with chroma scaling filter, and a neural network-based filter, etc. Alternatively, when the filter unit 208 determines that a reconstructed block is not used as a reference for decoding other blocks, the filter unit 208 performs loop filtering on one or more target samples in the reconstructed block. Herein, the output of the filter unit 208 is a decoded picture or sub-picture, which is buffered in the DPB unit 209. The DPB unit 209 outputs decoded pictures or sub-pictures based on timing and control information. The pictures stored in the DPB unit 209 may also be used as references for performing inter-prediction or intra-prediction through the prediction unit 202.

Further, the decoder 200 may be a device having a second processor and a second memory storing computer programs. When the second processor reads and executes the computer programs, the decoder 200 reads the input bitstream and generates a corresponding decoded video. In addition, the decoder 200 may also be a computing device having one or more chips. The units implemented as integrated circuits on the chips have connection and data exchange functions similar to those of the corresponding units in FIG. 5.

It should also be noted that, when the embodiments of the present disclosure are applied to the encoder 100, a “current block” specifically refers to a block currently to be encoded in a video image (also referred to simply as an “coding block”); when the embodiments of the present disclosure are applied to the decoder 200, a “current block” specifically refers to a block currently to be decoded in a video image (also referred to simply as a “coding block”).

Based on FIG. 4, the encoding method in the embodiments of the present disclosure is mainly applied to the “filter unit 113” portion of the encoder 100.

Based on FIG. 5, the decoding method in the embodiments of the present disclosure is mainly applied to the “filter unit 208” portion of the decoder 200.

That is, the encoding and decoding method in the embodiments of the present disclosure may be applied to a video encoding system (referred to simply as an “encoder”), may also be applied to a video decoding system (referred to simply as a “decoder”), and may even be simultaneously applied to both a video encoding system and a video decoding system, without any limitation here.

The technical solutions in the embodiments of the present disclosure will be described clearly and completely below with reference to the accompanying drawings in the embodiments of the present disclosure.

An embodiment of the present disclosure proposes a decoding method. The method is applied to a decoder and is used to perform filtering processing through CCALF. FIG. 6 is a schematic diagram of the decoding method proposed by the embodiment of the present disclosure. As shown in FIG. 6, the method for decoding processing performed by the decoder may include the following operations 101-103.

In operation 101: a bitstream is decoded to determine first identification information.

In the embodiment of the present disclosure, by decoding the bitstream, the first identification information may be determined. The first identification information may be used to determine whether the CCALF is used to perform filtering processing on the current colour component of the current picture.

That is to say, in the embodiment of the present disclosure, the first identification information determined by decoding the bitstream may determine whether CCALF is used to perform filtering processing on the current colour component of the current picture.

It should be noted that, in the embodiment of the present disclosure, in a video picture, a first colour component, a second colour component, and a third colour component are generally used to represent a Coding Block (CB). The three colour components are a luma component, a blue colour component, and a red colour component, respectively. Specifically, the luma component is usually represented by the symbol Y, the blue colour component is usually represented by the symbol Cb or U, and the red colour component is usually represented by the symbol Cr or V. In this way, the video picture may be represented in YCbCr format or YUV format.

Further, in the embodiment of the present disclosure, the current colour component of the current picture may be understood as the blue colour component of the current picture, or may be understood as the red colour component of the current picture, i.e., the current colour component may be a U component or a V component, which is not specifically limited in the present disclosure.

Exemplarily, in some embodiments, when the value of the first identification information is a first value, it may be determined that CCALF is not used to perform filtering processing on the current colour component of the current picture.

Exemplarily, in some embodiments, when the value of the first identification information is a second value, it may be determined that CCALF is used to perform filtering processing on the current colour component of the current picture.

It should be noted that, in the embodiment of the present disclosure, the first identification information may be used to indicate whether CCALF is used to perform filtering processing on the current colour component of the current picture. In addition, the first value is different from the second value, and the first value and the second value may be in a parameter form or in a numerical form. In general, the first identification information may be a parameter written in a Picture Parameter Set (PPS), or may be a parameter written in a Sequence Parameter Set (SPS). The first identification information may also be a flag, which is not limited herein.

It should also be noted that, if the first identification information is a flag, then in a specific example, the first value may be set to 1 and the second value may be set to 0. In another specific example, the first value may also be set to true and the second value may also be set to false. In yet another specific example, the first value may also be set to 0 and the second value may also be set to 1; or the first value may also be set to false and the second value may also be set to true. The first value and the second value in the embodiments of the present disclosure are not limited in any way.

Taking the first value being 1 and the second value being 0 as an example, in the embodiment of the present disclosure, if the value of the first identification information is 1, it may be determined that CCALF is not used to perform filtering processing on the current colour component of the current picture. Otherwise, if the value of the first identification information is 0, it may be determined that CCALF is used to perform filtering processing on the current colour component of the current picture.

In operation 102: in response to determining based on the first identification information that CCALF is used to perform filtering processing on the current colour component of the current picture, the filter coefficients and the scale factor corresponding to the current colour component are determined.

In the embodiment of the present disclosure, after decoding the bitstream to determine the first identification information, in response to determining based on the first identification information that CCALF is used to perform filtering processing on the current colour component of the current picture, the filter coefficients and the scale factor corresponding to the current colour component may be further determined.

It should be noted that, in the embodiment of the present disclosure, for the current colour component of the current picture, if it is determined, based on the first identification information, that CCALF is used to perform filtering processing, then the scale factor and filter coefficients used in the CCALF filtering process need to be further determined. The scale factor corresponds to the current colour component of the current picture, and the filter coefficients are related to the scale factor.

It may be understood that, in the embodiment of the present disclosure, for the current colour component of the current picture, the determined corresponding scale factor and filter coefficients may be applied to the filtering processing for the current colour component.

That is to say, in the embodiment of the present disclosure, when performing CCALF filtering processing on the current colour component of the current picture, one scale factor corresponding to the current colour component of the current picture may be used, i.e., each colour component only corresponds to one scale factor, and the scale factors corresponding to different colour components may be the same or different, which is not specifically limited in the present disclosure.

It should be noted that, in the embodiment of the present disclosure, the filter coefficients may be filter coefficients after integerization processing. Specifically, at the encoding side, the scale factor may be selected to scale the solved floating-point filter coefficients, and then integerization is performed on the scaled filter coefficients, to obtain the integerized filter coefficients.

Further, in the embodiment of the present disclosure, when determining the scale factor corresponding to the current colour component, first scale factor information corresponding to the current colour component may be determined first; and then the scale factor corresponding to the current colour component may be determined based on the first scale factor information.

It should be noted that, in the embodiment of the present disclosure, the first scale factor information may be used to determine the scale factor corresponding to the current colour component. The first scale factor information may include any one of the following: an index value of the scale factor, a value of the scale factor, or a relevant value of the scale factor.

Further, in the embodiment of the present disclosure, when determining the scale factor corresponding to the current colour component based on the first scale factor information, the scale factor corresponding to the current colour component may be determined based on the first scale factor information and a scale factor candidate list.

It should be noted that, in the embodiment of the present disclosure, if the first scale factor information is the index value of the scale factor corresponding to the current colour component, then the candidate scale factor indicated by the index value of the scale factor in the scale factor candidate list may be determined as the scale factor corresponding to the current colour component.

It should be understood that, in the embodiment of the present disclosure, at least one scale factor candidate list may be preset, and the scale factor candidate list is used to determine the scale factor corresponding to the current colour component.

It should be noted that, in the embodiment of the present disclosure, the number of preset scale factor candidate lists may be any integer greater than 0. For example, the number of scale factor candidate lists may be 1 or 3, which is not specifically limited in the present disclosure.

It may be understood that, in the embodiment of the present disclosure, for the encoding side, the number of scale factor candidate lists may be set; and for the decoding side, the number of scale factor candidate lists may be set, or may be determined based on list number information transmitted by the encoding side.

Correspondingly, in the embodiment of the present disclosure, since the number of preset scale factor candidate lists may be any value, after setting at least one scale factor candidate list, list number information corresponding to the at least one scale factor candidate list may also be signalled into the bitstream. Correspondingly, at the decoding side, by decoding the bitstream, the list number information indicating the number of scale factor candidate lists is determined, and then the number of scale factor candidate lists may be determined based on the list number information, so that at least one scale factor candidate list may be set.

It should be noted that, in the embodiment of the present disclosure, the preset scale factor candidate list may include at least one candidate scale factor. The at least one candidate scale factor are all greater than 0.

It may be understood that, in the embodiment of the present disclosure, the number of candidate scale factors included in each preset scale factor candidate list may be any integer greater than 0. For example, the scale factor candidate list may include 4 candidate scale factors, or may also include 5 candidate scale factors, which is not specifically limited in the present disclosure.

Correspondingly, in the embodiment of the present disclosure, for different scale factor candidate lists, the number of candidate scale factors included in each scale factor candidate list may be the same or different, which is not specifically limited in the present disclosure.

Exemplarily, in some embodiments, 3 scale factor candidate lists are preset. Herein, scale factor candidate list 1 includes 4 candidate scale factors, scale factor candidate list 2 includes 7 candidate scale factors, and scale factor candidate list 3 includes 2 candidate scale factors.

It should be noted that, in the embodiment of the present disclosure, the values of the candidate scale factors included in each preset scale factor candidate list may be any value greater than 0, which is not specifically limited in the present disclosure.

Exemplarily, in some embodiments, the scale factor candidate list includes 4 candidate scale factors, and the values of the 4 candidate scale factors are 7, 8, 9, and 10, respectively.

That is to say, in the embodiment of the present disclosure, when the first scale factor information is the index value of the scale factor corresponding to the current colour component, the corresponding scale factor may be determined from the preset scale factor candidate list based on the index value.

Exemplarily, in some embodiments, Table 1 is a possible form of a scale factor candidate list, herein, the scale factor candidate list includes 4 candidate scale factors, which are 7, 8, 9, and 10, respectively. If the first scale factor information is the scale factor index value of 2, then the candidate scale factor 8 may be determined as the scale factor corresponding to the current colour component.

TABLE 1

| Index value | Candidate scale factor |
|---|---|
| 1 | 7 |
| 2 | 8 |
| 3 | 9 |
| 4 | 10 |

Further, in the embodiment of the present disclosure, when determining the scale factor corresponding to the current colour component based on the first scale factor information, the first scale factor information may be determined as the scale factor corresponding to the current colour component.

It should be noted that, in the embodiment of the present disclosure, if the first scale factor information is a value of the scale factor corresponding to the current colour component, the first scale factor information may be directly determined as the scale factor corresponding to the current colour component.

Further, in the embodiment of the present disclosure, when determining the scale factor corresponding to the current colour component based on the first scale factor information, conversion may be performed based on the first scale factor information, so that the scale factor corresponding to the current colour component may be determined.

It should be noted that, in the embodiment of the present disclosure, if the first scale factor information is a relevant value of the scale factor corresponding to the current colour component, conversion may be further performed based on the first scale factor information to obtain the scale factor corresponding to the current colour component.

Exemplarily, in some embodiments, after determining the first scale factor information, during the process of performing conversion based on the first scale factor information, a numerical operation result between the first scale factor information and a preset value may be selected and determined as the corresponding scale factor. Herein, the preset value may be any value, which is not specifically limited in the present disclosure. For example, a summation operation may be performed on the first scale factor information and the value 6 (the preset value), and the sum result is determined as the corresponding scale factor.

It should be understood that, in the embodiment of the present disclosure, the relevant value of the scale factor may be a value in another form generated by converting the value of the scale factor.

That is to say, in the embodiment of the present disclosure, the form of the first scale factor information transmitted from the encoder side to the decoder side may be any form. For example, the first scale factor information includes, but is not limited to, an index value of the scale factor, a value of the scale factor, and a relevant value of the scale factor, which is not specifically limited in the present disclosure.

It should be noted that, in the embodiment of the present disclosure, at the encoder side, the first scale factor information may be signalled into the bitstream in any manner for transmission to the decoder side. Herein, the encoding of the first scale factor information includes, but is not limited to: fixed-length coding, variable-length coding, or adaptive context coding, etc., which is not specifically limited in the embodiments of the present disclosure.

Further, in the embodiment of the present disclosure, in response to determining based on the first identification information that CCALF is used to perform filtering processing on the current colour component of the current picture, decoding the bitstream may be continued to determine an APS index corresponding to the current picture; then, an APS unit corresponding to the current picture may be determined based on the APS index; finally, second identification information may be determined based on the APS unit. Herein, the second identification information is used to determine whether CCALF is used to perform filtering processing on the current colour component of the current block.

It should be noted that, in the embodiment of the present disclosure, the APS index corresponding to the current picture may be used to indicate the APS unit corresponding to the current picture. Herein, the APS index corresponding to the current picture may be an APS ID corresponding to the current picture.

That is to say, in the embodiment of the present disclosure, if the first identification information indicates that the current colour component of the current picture is used for performing filtering processing through CCALF, then the APS ID corresponding to the current picture may be further determined, and a corresponding APS unit is selected based on the APS ID corresponding to the current picture.

It should be noted that, in the embodiment of the present disclosure, the APS unit corresponding to the current picture may include CCALF parameter information corresponding to the current colour component of the current picture. Herein, the CCALF parameter information may be used for the CCALF filtering processing of the current colour component of the current picture.

That is to say, in the embodiment of the present disclosure, parameter information (i.e., the CCALF parameter information) related to the CCALF filtering processing may be included in the APS unit corresponding to the current picture, and the CCALF filtering processing on the current colour component of the current picture may be completed through the CCALF parameter information.

It should be noted that, in the embodiment of the present disclosure, the CCALF parameter information may include the second identification information. That is, the second identification information used to indicate whether CCALF is used to perform filtering processing on the current colour component of the current block may be included in the APS unit. Herein, the second identification information corresponding to the current block may be determined by parsing the APS unit.

That is to say, in the embodiment of the present disclosure, whether CCALF is used to perform filtering processing on the current colour component of the current block may be determined through the second identification information which is determined through the APS unit.

Exemplarily, in some embodiments, when a value of the second identification information is a third value, it may be determined that CCALF is not used to perform filtering processing on the current colour component of the current block.

Exemplarily, in some embodiments, when the value of the second identification information is a fourth value, it may be determined that CCALF is used to perform filtering processing on the current colour component of the current block.

It should be noted that, in the embodiment of the present disclosure, the second identification information may be used to indicate whether CCALF is used to perform filtering processing on the current colour component of the current block. In addition, the third value is different from the fourth value, and the third value and the fourth value may be in a parameter form or a numerical form. In general, the second identification information may be a parameter written in the APS unit corresponding to the current picture.

Exemplarily, in some embodiments, the third value may be set to 1 and the fourth value may be set to 0. In another specific example, the third value may also be set to true and the fourth value may also be set to false. In yet another specific example, the third value may also be set to 0 and the fourth value may also be set to 1; or, the third value may also be set to false and the fourth value may also be set to true. The third value and the fourth value in the embodiments of the present disclosure are not limited in any way.

Taking the third value being 1 and the fourth value being 0 as an example, in the embodiment of the present disclosure, if the value of the first identification information is 1, it may be determined that CCALF is not used to perform filtering processing on the current colour component of the current block. Otherwise, if the value of the first identification information is 0, it may be determined that CCALF is used to perform filtering processing on the current colour component of the current block.

Further, in the embodiment of the present disclosure, in response to determining based on the second identification information that CCALF is used to perform filtering processing on the current colour component of the current block, a process of determining a reconstructed block of the current block based on the scale factor and the filter coefficients may continue to be performed.

That is, in the embodiment of the present disclosure, after determining the second identification information based on the APS unit, if the second identification information indicates that CCALF is used to perform filtering processing on the current colour component of the current block, CCALF filtering may be further performed on the current colour component of the current block based on the filter coefficients and the scale factor corresponding to the current colour component, and finally, the reconstructed block of the current block may be determined.

Further, in the embodiment of the present disclosure, first scale factor information corresponding to the current colour component may be determined based on the APS unit.

It should be noted that, in the embodiment of the present disclosure, the CCALF parameter information may include the first scale factor information. That is, the first scale factor information used to indicate the scale factor corresponding to the current colour component may be included in the APS unit. Herein, the first scale factor information corresponding to the current colour component may be determined by parsing the APS unit.

Further, in the embodiment of the present disclosure, the filter coefficients corresponding to the current colour component may be determined based on the APS unit.

It should be noted that, in the embodiment of the present disclosure, the CCALF parameter information may include the filter coefficients. That is, the filter coefficients corresponding to the current colour component may be included in the APS unit. Herein, the filter coefficients corresponding to the current colour component may be determined by parsing the APS unit

It should be understood that, in the embodiment of the present disclosure, the filter coefficients determined by decoding the bitstream may be represented by using 4 bits. Herein, 1 bit is used to determine a sign of the filter coefficients, and 3 bits are used to determine values of the filter coefficients.

Exemplarily, in some embodiments, a value of the most significant bit may be used to determine a sign of the filter coefficients. For example, 1 indicates that the sign is negative, and 0 indicates that the sign is positive. The other 3 bits are used to determine a value of the filter coefficients. For example, −32 may be represented as 1101 by using 4 bits, and 32 may be represented as 0101 by using 4 bits.

That is, in the embodiment of the present disclosure, in response to determining based on the first identification information that CCALF is used to perform filtering processing on the current colour component of the current picture, the CCALF parameter information determined by parsing the APS unit corresponding to the current picture may at least include the second identification information, the first scale factor information, and the filter coefficients.

Exemplarily, in some embodiments, the CCALF parameter information may at least include one or more of the following information: an index in a candidate list (the first scale factor information), the number of filter groups, filter sorting, filter coefficients (filtering coefficients), whether a CTU uses CCALF (the second identification information), and a filter category used by the CTU.

It should be noted that, for a video picture, the video picture may be partitioned into multiple picture blocks, each picture block to-be-decoded may be referred to as a coding block, and the current block herein specifically refers to a current coding block to-be-predicted. Herein, the current block may be a CTU, or even a Coding Unit (CU), a Prediction Unit (PU), etc., which is not limited in any way in the embodiments of the present disclosure.

In operation 103: a reconstructed block of the current block is determined based on the scale factor and the filter coefficients.

In the embodiment of the present disclosure, if it is determined based on the first identification information that CCALF is used to perform filtering processing on the current colour component of the current picture, then after determining the filter coefficients and the scale factor corresponding to the current colour component, the reconstructed block of the current block may be further determined based on the scale factor and the filter coefficients.

Further, in the embodiment of the present disclosure, when determining the reconstructed block of the current block based on the scale factor and the filter coefficients, for a current sample in the current block, a filtered reconstructed value of the current colour component of the current sample may be determined based on a luma reconstructed value of a reference sample for the current sample, a luma reconstructed value of the current sample, a reconstructed value of the current colour component of the current sample, the scale factor, and the filter coefficients; then, the reconstructed block of the current block may be determined based on the filtered reconstructed value of the current colour component of the current sample.

It should be noted that, in the embodiment of the present disclosure, after determining the filter coefficients and the scale factor corresponding to the current colour component, for any sample in the current block, filtering processing may be further performed on the reconstructed value of the current colour component of the sample in combination with a luma reconstructed value of a reference sample and a luma reconstructed value of the sample; and finally, a filtered reconstructed value of the current colour component of the sample is determined. Part or all of the samples in the current block are sequentially traversed, and filtered reconstructed values of the current colour component of the part or all of the samples are obtained, so that the reconstructed block corresponding to the current colour component of the current block may be determined.

Exemplarily, in some embodiments, based on the above formula (6), for the current sample, filtering processing is performed through the reconstructed value (recC) of the current colour component of the current sample, a luma reconstructed value (recY(i)) of a reference sample i, a luma reconstructed value (recY(x)) of the current sample, the scale factor (scale) of the current colour component, and the filter coefficients

$${c}_{i}^{f} ,$$

to determine the filtered reconstructed value (recC′) of the current colour component of the current sample.

It should be noted that, in the embodiment of the present disclosure, when determining the reconstructed block of the current block based on the filtered reconstructed value of the current colour component of the current sample, for a sample subjected to the filtering processing, the filtered reconstructed value may be written into the reconstructed block, and for a sample not subjected to the filtering processing, a reconstructed value of the sample may be directly written into the reconstructed block.

That is, in the embodiment of the present disclosure, it may be selected to perform filtering processing on all or part of the samples of the current block. Herein, for a sample requiring filtering, the filtering processing is performed on this sample and then the filtered sample is written into a reconstructed picture; while for a sample not requiring filtering, this sample is directly written into the reconstructed picture.

In summary, through the decoding method proposed in the above operation 101 to operation 103, a filter precision adaptive method is designed. In the CCALF technology, an optimal scale factor is adaptively selected for a colour component within a picture; herein, all filters of the same colour component within the same picture use the same scale factor, which can reduce bit cost. In addition, the global optimal solution can be more closely approached under the framework of the CCALF algorithm, and coding performance can be improved.

It may be understood that, in the embodiment of the present disclosure, at the decoder side, if CCALF is used to perform filtering on the current colour component of the current picture, then a corresponding APS unit may be selected based on an APS ID used by the current picture, and the scale factor of the current colour component may be obtained based on an index of the scale factor corresponding to the current colour component in the APS unit in a candidate list. It should be noted that all filters of the current colour component of the current picture use this scale factor.

Exemplarily, in some embodiments, taking a syntax and semantics level in ECM as an example, the modifications made by the decoding method proposed in the embodiments of the present disclosure at the syntax and semantics level are described as follows:

| | |
|---|---|
| if ( alf_cross_component_cb_filter_signal_flag ) { | |
| alf_cross_component_cb_filters_signalled_minus1 | ue(v) |
| alf_cross_component_cb_coeff_prec_idx | u(2) |
| for( k = 0; k < (alf_cross_component_cb_filters_signalled_minus1+1); k++ ) | |
| { | |
| for ( j = 0; j < 24; j++ ) { | |
| alf_cc_cb_mapped_coeff_abs [ k ][ j ] | u(3) |
| if ( alf_cc_cb_mapped_coeff_abs [ k ][ j ] != 0) | |
| alf_cc_cb_coeff_sign [ k ][ j ] | u(1) |
| } | |
| } | |
| } | |
| if ( alf_cross_component_cr_filter_signal_flag ) { | |
| alf_cross_component_cr_filters_signalled_minus1 | ue(v) |
| alf_cross_component_cr_coeff_prec_idx | u(2) |
| for( k = 0; k < (alf_cross_component_cr_filters_signalled_minus1+1); k++ ) | |
| { | |
| for ( j = 0; j < 24; j++ ) { | |
| alf_cc_cr_mapped_coeff_abs [ k ][ j ] | u(3) |
| if ( alf_cc_cr_mapped_coeff_abs [ k ][ j ] != 0) | |
| alf_cc_cr_coeff_sign [ k ][ j ] | u(1) |
| } | |
| } | |
| } | |

Here, alf_cross_component_cb_coeff_prec_idx indicates an index (an index value of a scale factor) of an optimal scale factor used by a chroma U component in a candidate list (a scale factor candidate list). In a current implementation, the number N of candidate scale factors in the scale factor candidate list is set to 4, so only 2 bits are required to encode the index. alf_cross_component_cr_coeff_prec_idx is an index of an optimal scale factor of a chroma V component.

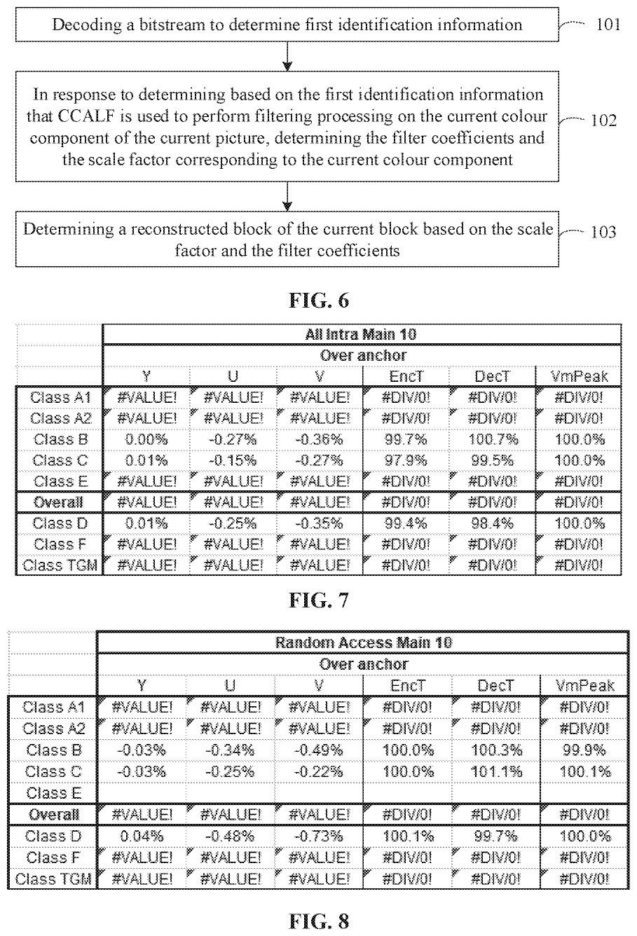

Exemplarily, in some embodiments, FIG. 7 is a first test result of the decoding method proposed in the embodiments of the present disclosure, and FIG. 8 is a second test result of the decoding method proposed in the embodiments of the present disclosure. The decoding method proposed in the embodiments of the present disclosure is implemented on reference software ECM-10.0. Herein, the number N of candidate scale factors in the scale factor candidate list is set to 4, and the scale factor candidate list is {7, 8, 9, 10}. Under an All Intra (AI) configuration condition, testing is performed on part of test sequences required by ECM, and test results are shown in FIG. 7. Under Classes B, C, and D, average changes of BD-rate on Y, U, and V components are 0.00%, −0.22%, and −0.33%, respectively. Under a Random Access configuration condition, testing is performed on part of the test sequences required by ECM, and test results are shown in FIG. 8. Under Classes B, C, and D, average changes of BD-rate on Y, U, and V components are 0.00%, −0.36%, and −0.48%, respectively. It can be seen that data of the above test results indicates that the decoding method proposed in the embodiments of the present disclosure improves coding performance.

That is, the decoding method proposed in the embodiments of the present disclosure allows conventional CCALF to obtain additional performance gains in a case where complexities at an encoder side and a decoder side are almost unchanged.

Herein, Class is a video class, Sequence is a specific test sequence, and Y, Cb, and Cr indicate performances of three components of video luma and chroma. Values in the tables are BD-rate. BD-rate is a way to measure algorithm performance, indicating the change in bit rate and Peak Signal to Noise Ratio (PSNR) (or SSIM) of a new coding algorithm relative to an original algorithm. An overall negative value indicates that performance is improved, and the larger the absolute value, the greater the performance improvement.

An embodiment of the present disclosure provides a decoding method. At a decoder side, a bitstream is decoded to determine first identification information; in response to determining based on the first identification information that CCALF is used to perform filtering processing on the current colour component of the current picture, the filter coefficients and the scale factor corresponding to the current colour component are determined; and a reconstructed block of the current block is determined based on the scale factor and the filter coefficients. That is to say, in the embodiment of the present disclosure, the encoder side may adaptively determine a corresponding scale factor for the current colour component of the current picture; at the decoder side, in response to determining that CCALF is used to perform filtering processing on the current colour component of the current picture, the scale factor corresponding to the current colour component of the current picture may be used to perform CCALF filtering processing on the current colour component; herein, each filter for the current colour component uses the same scale factor, thereby obtaining a more ideal filtering effect and improving coding performance.

Another embodiment of the present disclosure proposes a decoding method. The method is applied to a decoder and used to perform filtering processing through an Adaptive Loop Filter (ALF). The method for decoding processing performed by the decoder may include the following operations 201-204.

In operation 201: a bitstream is decoded to determine first identification information.

In the embodiment of the present disclosure, by decoding the bitstream, the first identification information may be determined. Herein, the first identification information may be used to determine whether ALF is used to perform filtering processing on the current colour component of the current picture.

That is, in a case where the decoding method proposed in the present disclosure is applied to CCALF, the first identification information may be used to determine whether CCALF is used to perform filtering processing on the current colour component of the current picture; and in a case where the decoding method proposed in the present disclosure is applied to ALF, the first identification information may be used to determine whether ALF is used to perform filtering processing on the current colour component of the current picture.

Exemplarily, in some embodiments, when a value of the first identification information is a first value, it may be determined that ALF is not used to perform filtering processing on the current colour component of the current picture.

Exemplarily, in some embodiments, when the value of the first identification information is a second value, it may be determined that ALF is used to perform filtering processing on the current colour component of the current picture.

In operation 202: in response to determining based on the first identification information that ALF is used to perform filtering processing on the current colour component of the current picture, third identification information may be determined.

In the embodiment of the present disclosure, after decoding the bitstream to determine the first identification information, in response to determining based on the first identification information that ALF is used to perform filtering processing on the current colour component of the current picture, the third identification information may be further determined.

It should be noted that, in the embodiment of the present disclosure, the third identification information may be used to determine whether non-fixed filter parameters in ALF are used to perform filtering processing on the current colour component of the current picture.

Exemplarily, in some embodiments, when a value of the third identification information is a fifth value, it may be determined that non-fixed filter parameters in ALF are not used to perform filtering processing on the current colour component of the current picture.

Exemplarily, in some embodiments, when the value of the third identification information is a sixth value, it may be determined that non-fixed filter parameters in ALF are used to perform filtering processing on the current colour component of the current picture.

It should be noted that, in the embodiment of the present disclosure, the third identification information may be used to indicate whether non-fixed filter parameters in ALF are used to perform filtering processing on the current colour component of the current picture. In addition, the fifth value is different from the sixth value, and the fifth value and the sixth value may be in a parameter form or a numerical form. Generally, the third identification information may be a parameter written in a PPS, or a parameter written in an SPS, or the third identification information may also be a flag, which is not limited in any way herein.

It should also be noted that, if the third identification information is a flag, then in a specific example, the fifth value may be set to 1, and the sixth value may be set to 0. In another specific example, the fifth value may also be set to true, and the sixth value may also be set to false. In yet another specific example, the fifth value may also be set to 0, and the sixth value may also be set to 1; or, the fifth value may also be set to false, and the sixth value may also be set to true. The fifth value and the sixth value in the embodiments of the present disclosure are not limited in any way.

Taking the fifth value being 1 and the sixth value being 0 as an example, in the embodiment of the present disclosure, if the value of the third identification information is 1, then it may be determined that non-fixed filter parameters in ALF are not used to perform filtering processing on the current colour component of the current picture. Otherwise, if the value of the third identification information is 0, it may be determined that non-fixed filter parameters in ALF are used to perform filtering processing on the current colour component of the current picture.

In operation 203: in response to determining based on the third identification information that non-fixed filter parameters in ALF are used to perform filtering processing on the current colour component of the current picture, filter coefficients, clipping information and a scale factor corresponding to the current colour component may be determined.

In the embodiment of the present disclosure, in response to determining based on the third identification information that non-fixed filter parameters in ALF are used to perform filtering processing on the current colour component of the current picture, the filter coefficients, the clipping information and the scale factor corresponding to the current colour component may be further determined.

It should be noted that, in the embodiment of the present disclosure, for the current colour component of the current picture, if it is determined based on the third identification information that non-fixed filter parameters in ALF are used to perform filtering processing, then it is required to further determine the scale factor, the filter coefficients, and the clipping information used in an ALF filtering process. Herein, the scale factor corresponds to the current colour component of the current picture, and the filter coefficients are related to the scale factor.

That is, in the embodiment of the present disclosure, when performing ALF filtering processing on the current colour component of the current picture, a scale factor corresponding to the current colour component of the current picture may be used, that is, each colour component only corresponds to one scale factor. Scale factors corresponding to different colour components may be the same or different, which is not specifically limited in the present disclosure.

It should be noted that, in the embodiment of the present disclosure, the filter coefficients may be filter coefficients subjected to integerization processing. Specifically, at the encoder side, a scale factor may be selected and used to scale solved floating-point filter coefficients, and then the integerization processing is performed on the scaled filter coefficients to obtain integerized filter coefficients.

Further, in the embodiment of the present disclosure, when determining the scale factor corresponding to the current colour component, first scale factor information corresponding to the current colour component may be first determined; and then the scale factor corresponding to the current colour component may be determined based on the first scale factor information.

It should be noted that, in the embodiment of the present disclosure, the first scale factor information may be used to determine the scale factor corresponding to the current colour component. Herein, the first scale factor information may include any one of the following: an index value of the scale factor, a value of the scale factor, and a relevant value of the scale factor.

Further, in the embodiment of the present disclosure, when determining the scale factor corresponding to the current colour component based on the first scale factor information, the scale factor corresponding to the current colour component may be determined based on the first scale factor information and a scale factor candidate list.

It should be noted that, in the embodiment of the present disclosure, if the first scale factor information is the index value of the scale factor corresponding to the current colour component, then a candidate scale factor indicated by the index value of the scale factor in the scale factor candidate list may be determined as the scale factor corresponding to the current colour component.

It may be understood that, in the embodiment of the present disclosure, at least one scale factor candidate list may be preset, and the scale factor candidate list is used to determine the scale factor corresponding to the current colour component.

It should be noted that, in the embodiment of the present disclosure, the number of preset scale factor candidate lists may be any integer greater than 0. For example, the number of scale factor candidate lists may be 1 or 3, which is not specifically limited in the present disclosure.

It may be understood that, in the embodiment of the present disclosure, for the encoder side, the number of scale factor candidate lists may be preset; and for the decoder side, the number of scale factor candidate lists may be preset, or may be determined based on list number information transmitted by the encoder side.

Correspondingly, in the embodiment of the present disclosure, since the number of preset scale factor candidate lists is any value, list number information corresponding to at least one scale factor candidate list may be signalled into the bitstream after setting the at least one scale factor candidate list. Correspondingly, at the decoder side, by decoding the bitstream, list number information indicating the number of scale factor candidate lists is determined, and then the number of scale factor candidate lists may be determined based on the list number information, so that the at least one scale factor candidate list may be set.

It should be noted that, in the embodiment of the present disclosure, the preset scale factor candidate list may include at least one candidate scale factor. Herein, all of the at least one candidate scale factor are greater than 0.

It may be understood that, in the embodiment of the present disclosure, the number of candidate scale factors included in each preset scale factor candidate list may be any integer greater than 0. For example, the scale factor candidate list includes 4 candidate scale factors, or 5 candidate scale factors, which is not specifically limited in the present disclosure.

Correspondingly, in the embodiment of the present disclosure, for different scale factor candidate lists, the number of candidate scale factors included in each scale factor candidate list may be the same or different, which is not specifically limited in the present disclosure.

Exemplarily, in some embodiments, three scale factor candidate lists are preset. Herein, scale factor candidate list 1 includes 4 candidate scale factors, scale factor candidate list 2 includes 7 candidate scale factors, and scale factor candidate list 3 includes 2 candidate scale factors.

It should be noted that, in the embodiment of the present disclosure, values of candidate scale factors included in each preset scale factor candidate list may be any value greater than 0, which is not specifically limited in the present disclosure.

Exemplarily, in some embodiments, the scale factor candidate list includes 4 candidate scale factors, and values of the 4 candidate scale factors are 7, 8, 9 and 10, respectively.

That is to say, in the embodiment of the present disclosure, when the first scale factor information is the index value of the scale factor corresponding to the current colour component, the corresponding scale factor may be determined from a preset scale factor candidate list based on the index value.

Further, in the embodiment of the present disclosure, when determining the scale factor corresponding to the current colour component based on the first scale factor information, the first scale factor information may be determined as the scale factor corresponding to the current colour component.

It should be noted that, in the embodiment of the present disclosure, if the first scale factor information is the value of the scale factor corresponding to the current colour component, then the first scale factor information may be directly determined as the scale factor corresponding to the current colour component.

Further, in the embodiment of the present disclosure, when determining the scale factor corresponding to the current colour component based on the first scale factor information, conversion may be performed based on the first scale factor information, so that the scale factor corresponding to the current colour component can be determined.

It should be noted that, in the embodiment of the present disclosure, if the first scale factor information is the related numerical value of the scale factor corresponding to the current colour component, then conversion may be further performed based on the first scale factor information to obtain the scale factor corresponding to the current colour component.

Exemplarily, in some embodiments, after determining the first scale factor information, during the process of performing conversion based on the first scale factor information, a numerical operation result between the first scale factor information and a preset value may be selected and determined as the corresponding scale factor. Herein, the preset value may be any value, which is not specifically limited in the present disclosure. For example, a summation operation may be performed on the first scale factor information and the value 6 (the preset value), and the sum result is determined as the corresponding scale factor.

It may be understood that, in the embodiment of the present disclosure, the relevant value of the scale factor may be a value in another form generated by converting the value of the scale factor.

That is to say, in the embodiment of the present disclosure, the form of the first scale factor information transmitted from the encoder side to the decoder side may be any form. For example, the first scale factor information includes, but is not limited to, an index value of the scale factor, a value of the scale factor, and a relevant value of the scale factor, which is not specifically limited in the present disclosure.

It should be noted that, in the embodiment of the present disclosure, at the encoder side, the first scale factor information may be signalled into the bitstream in any manner and transmitted to the decoder side. Herein, the encoding of the first scale factor information includes, but is not limited to: fixed-length coding, variable-length coding, or adaptive context coding, etc., which is not specifically limited in the embodiments of the present disclosure.

Further, in the embodiment of the present disclosure, in response to determining based on the first identification information that ALF is used to perform filtering processing on the current colour component of the current picture, decoding the bitstream may be continued to determine an APS index corresponding to the current picture; then, an APS unit corresponding to the current picture may be determined based on the APS index; finally, the second identification information may be determined based on the APS unit. Herein, the second identification information is used to determine whether ALF is used to perform filtering processing on the current colour component of the current block.

It should be noted that, in the embodiment of the present disclosure, the APS index corresponding to the current picture may be used to indicate the APS unit corresponding to the current picture. Herein, the APS index corresponding to the current picture may be an APS ID corresponding to the current picture.

That is, in the embodiment of the present disclosure, if the first identification information indicates that ALF is used to perform filtering processing on the current colour component of the current picture, then the APS ID corresponding to the current picture may be further determined, and a corresponding APS unit is selected based on the APS ID corresponding to the current picture.

It should be noted that, in the embodiment of the present disclosure, the APS unit corresponding to the current picture may include ALF parameter information corresponding to the current colour component of the current picture. Herein, the ALF parameter information may be used for ALF filtering processing of the current colour component of the current picture.

That is, in the embodiment of the present disclosure, the APS unit corresponding to the current picture may include parameter information related to the ALF filtering processing, i.e., the ALF parameter information, and the ALF filtering processing on the current colour component of the current picture may be completed through the ALF parameter information.

It should be noted that, in the embodiment of the present disclosure, the ALF parameter information may include the second identification information. That is, the APS unit may include the second identification information used to indicate whether ALF is used to perform filtering processing on the current colour component of the current block. Herein, the second identification information corresponding to the current block may be determined by parsing the APS unit.

That is, in the embodiment of the present disclosure, whether ALF is used to perform filtering processing on the current colour component of the current block may be determined through the second identification information which is determined through the APS unit.

Exemplarily, in some embodiments, when a value of the second identification information is a third value, it may be determined that ALF is not used to perform filtering processing on the current colour component of the current block.

Exemplarily, in some embodiments, when the value of the second identification information is a fourth value, it may be determined that ALF is used to perform filtering processing on the current colour component of the current block.

It should be noted that, in the embodiment of the present disclosure, the second identification information may be used to indicate whether ALF is used to perform filtering processing on the current colour component of the current block. In addition, the third value is different from the fourth value, and the third value and the fourth value may be in a parameter form or a numerical form. Generally, the second identification information may be a parameter written in the APS unit corresponding to the current picture.

Exemplarily, in some embodiments, the third value may be set to 1, and the fourth value may be set to 0. In another specific example, the third value may also be set to true, and the fourth value may also be set to false. In yet another specific example, the third value may also be set to 0, and the fourth value may also be set to 1; alternatively, the third value may also be set to false, and the fourth value may also be set to true. The third value and the fourth value in the embodiment of the present disclosure are not limited in any way.

Taking the third value being 1 and the fourth value being 0 as an example, in the embodiment of the present disclosure, if the value of the first identification information is 1, it may be determined that ALF is not used to perform filtering processing on the current colour component of the current block. Otherwise, if the value of the first identification information is 0, it may be determined that ALF is used to perform filtering processing on the current colour component of the current block.

Further, in the embodiment of the present disclosure, in response to determining based on the second identification information that ALF is used to perform filtering processing on the current colour component of the current block, a process of determining a reconstructed block of the current block based on the scale factor, the filter coefficients, and the clipping information may continue to be performed.

That is, in the embodiment of the present disclosure, after determining the second identification information based on the APS unit, if the second identification information indicates that ALF is used to perform filtering processing on the current colour component of the current block, ALF filtering may be further performed on the current colour component of the current block based on the filter coefficients, the clipping information and the scale factor corresponding to the current colour component, and finally, a filtered block of the current block may be determined, and a corresponding reconstructed block may be further determined.

Further, in the embodiment of the present disclosure, first scale factor information corresponding to the current colour component may be determined based on the APS unit.

It should be noted that, in the embodiment of the present disclosure, the ALF parameter information may include the first scale factor information. That is, the APS unit may include the first scale factor information used to indicate the scale factor corresponding to the current colour component. Herein, the first scale factor information corresponding to the current colour component may be determined by parsing the APS unit.

Further, in the embodiment of the present disclosure, the filter coefficients and the clipping information corresponding to the current colour component may be determined based on the APS unit.

It should be noted that, in the embodiment of the present disclosure, the ALF parameter information may include the filter coefficients and the clipping information. That is, the APS unit may include the filter coefficients and the clipping information corresponding to the current colour component. Herein, the filter coefficients and the clipping information corresponding to the current colour component may be determined by parsing the APS unit.

It may be understood that, in the embodiment of the present disclosure, the filter coefficients determined by decoding the bitstream may be represented by using 4 bits. Herein, 1 bit is used to determine a sign of the filter coefficients, and 3 bits are used to determine a value of the filter coefficients.

Exemplarily, in some embodiments, a value of the most significant bit may be used to determine the sign of the filter coefficients. For example, 1 indicates that the sign is negative, 0 indicates that the sign is positive. The other 3 bits are used to determine the value of the filter coefficients. For example, −32 may be represented as 1101 by using 4 bits, and 32 may be represented as 0101 by using 4 bits.

That is, in the embodiment of the present disclosure, in response to determining based on the first identification information that ALF is used to perform filtering processing on the current colour component of the current picture, the ALF parameter information determined by parsing the APS unit corresponding to the current picture may at least include the second identification information, the first scale factor information, the filter coefficients, and the clipping information.

Exemplarily, in some embodiments, the ALF parameter information may at least include one or more of the following: an index in a candidate list (the first scale factor information), the number of filter groups, filter sorting, filter coefficients (the filtering coefficients), whether a CTU uses ALF (the second identification information), and a filter category used by the CTU.

Further, in the embodiment of the present disclosure, in response to determining based on the second identification information that ALF is used to perform filtering processing on the current colour component of the current block, a filter category of the current colour component of a sub-block of the current block may be calculated, and then the filter coefficients for the current colour component of the sub-block of the current block may be further determined based on the APS unit and the filter category for the current colour component of the sub-block of the current block.

It should be noted that, for a video picture, the video picture may be partitioned into multiple picture blocks, each picture block to-be-decoded may be referred to as a coding block, and the current block herein specifically refers to a current coding block to-be-predicted. Herein, the current block may be a CTU, or even a CU, a PU, etc., which is not limited in any way in the embodiment of the present disclosure.

In operation 204: a filtered block of the current block may be determined based on the scale factor, the filter coefficients, and the clipping information.

In the embodiment of the present disclosure, if the third identification information indicates that non-fixed filter parameters in ALF are used to perform filtering processing on the current colour component of the current picture, and after determining the filter coefficients, the clipping information and the scale factor corresponding to the current colour component, the ALF filtering processing may be further performed on the current block based on the scale factor, the filter coefficients, and the clipping information, so as to determine the filtered block of the current block.

Further, in the embodiment of the present disclosure, when determining the filtered block of the current block based on the scale factor, the filter coefficients and the clipping information, for a current sample in the current block, a filtered sample value of the current colour component of the current sample is determined based on a reconstructed value of a reference sample corresponding to the current sample, a reconstructed value of the current sample, reference information of the current colour component of the current sample, the scale factor, the filter coefficients, and the clipping information; then, a filtered sample block of the current block (that is, the filtered block of the current block) may be determined based on the filtered sample value of the current colour component of the current sample.

It should be noted that, in the embodiment of the present disclosure, after determining the filter coefficients, the clipping information and the scale factor corresponding to the current colour component, for any sample in the current block, filtering processing may be further performed on a reconstructed value of the current colour component of the sample in combination with a luma reconstructed value of a reference sample and a luma reconstructed value of the sample, and finally, a filtered reconstructed value of the current colour component of the sample is determined. Part or all of the samples in the current block are sequentially traversed and filtered reconstructed values of the current colour component of the part or all of the samples are obtained, so that the reconstructed block corresponding to the current colour component of the current block may be determined.

That is, the decoding method proposed in the present disclosure may be applied to both CCALF and ALF. Herein, the process of iteratively obtaining the ALF parameter information and the ALF filtering process are similar to those of CCALF.

Exemplarily, in some embodiments, at the encoder side, an optimal scale factor is adaptively selected for the luma and colour components of the current picture in ALF based on a preset scale factor list, and the scale factor and the ALF parameter information are signalled into the bitstream for transmission to the decoder side; at the decoder side, the scale factor and the ALF parameter information are determined by decoding the bitstream, and further, the filtering processing is performed by using the scale factor and the ALF parameter information.

Exemplarily, in some embodiments, taking a syntax and semantics level in ECM as an example, the modifications made by the decoding method proposed in the embodiments of the present disclosure at the syntax and semantics level are described as follows:

| | |
|---|---|
| if( alf_luma_filter_signal_flag ) { | |
| alf_luma_clip_flag | u(1) |
| alf_luma_num_filters_signalled_minus1 | ue(v) |
| alf_luma_coeff_prec_idx | u(2) |
| if( alf_luma_num_filters_signalled_minus1 > 0 ) | |
| for( filtIdx = 0; filtIdx < NumAlfFilters; filtIdx++ ) | |
| alf_luma_coeff_delta_idx[ filtIdx ] | u(v) |
| for( sfIdx = 0; sfIdx <= alf_luma_num_filters_signalled_minus1; sfIdx++ ) | |
| for( j = 0; j < 12; j++ ) { | |
| alf_luma_coeff_abs[ sfIdx ][ j ] | ue(v) |
| if( alf_luma_coeff_abs[ sfIdx ][ j ] ) | |
| alf_luma_coeff_sign[ sfIdx ][ j ] | u(1) |
| } | |
| if( alf_luma_clip_flag ) | |
| for( sfIdx = 0; sfIdx <= alf_luma_num_filters_signalled_minus1; sfIdx++ ) | |
| for( j = 0; j < 12; j++ ) | |
| alf_luma_clip_idx[ sfIdx ][ j ] | u(2) |
| } | |
| if( alf_chroma_filter_signal_flag ) { | |
| alf_chroma_clip_flag | u(1) |
| alf_chroma_num_alt_filters_minus1 | ue(v) |
| alf_chroma_coeff_prec_idx | u(2) |
| for( altIdx = 0; altIdx <= alf_chroma_num_alt_filters_minus1; altIdx++ ) { | |
| for( j = 0; j < 6; j++ ) { | |
| alf_chroma_coeff_abs[ altIdx ][ j ] | ue(v) |
| if( alf_chroma_coeff_abs[ altIdx ][ j ] > 0 ) | |
| alf_chroma_coeff_sign[ altIdx ][ j ] | u(1) |
| } | |
| if( alf_chroma_clip_flag ) | |
| for( j = 0; j < 6; j++ ) | |
| alf_chroma_clip_idx[ altIdx ][ j ] | u(2) |
| } | |
| } | |

Embodiments of the present disclosure provide a decoding method. At a decoder side, a bitstream is decoded to determine first identification information; in response to determining based on the first identification information that ALF is used to perform filtering processing on a current colour component of a current picture, third identification information is determined; in response to determining based on the third identification information that non-fixed filter parameters in the ALF are used to perform filtering processing on the current colour component of the current picture, the filter coefficients, the clipping information and the scale factor corresponding to the current colour component are determined; and a filtered block of a current block is determined based on the scale factor, the filter coefficients and the clipping information. That is to say, in the embodiments of the present disclosure, an encoder side may adaptively determine a corresponding scale factor for the current colour component of the current picture; at the decoder side, in response to determining that the ALF is used to perform filtering processing on the current colour component of the current picture, the scale factor corresponding to the current colour component of the current picture may be used to perform ALF filtering processing on the current colour component; herein, each filter for the current colour component uses the same scale factor, thereby obtaining a more ideal filtering effect and improving coding performance.

Another embodiment of the present disclosure provides an encoding method. The method is applied to an encoder and used to perform filtering processing through CCALF. FIG. 9 is a schematic diagram of an encoding method proposed in an embodiment of the present disclosure. As shown in FIG. 9, a method for encoding processing performed by the encoder may include the following operations 301-302.

In operation 301: a scale factor corresponding to a current colour component of a current picture is determined.

In the embodiments of the present disclosure, the encoder may first determine the scale factor corresponding to the current colour component of the current picture.

It should be noted that in the embodiments of the present disclosure, in a video picture, a first colour component, a second colour component, and a third colour component are generally used to represent a Coding Block (CB). The three colour components are a luma component, a blue colour component, and a red colour component, respectively. Specifically, the luma component is usually represented by the symbol Y, the blue colour component is usually represented by the symbol Cb or U, and the red colour component is usually represented by the symbol Cr or V. In this way, the video picture may be represented in YCbCr format or YUV format.

Further, in the embodiments of the present disclosure, the current colour component of the current picture may be understood as the blue colour component of the current picture, or may be understood as the red colour component of the current picture, that is, the current colour component may be a U component or a V component, which is not specifically limited in the present disclosure.

Further, in the embodiments of the present disclosure, at least one scale factor candidate list may be preset, and the scale factor candidate list is used to determine the scale factor corresponding to the current colour component.

It should be noted that in the embodiments of the present disclosure, the number of preset scale factor candidate lists may be any integer greater than 0. For example, the number of scale factor candidate lists may be 1 or 3, which is not specifically limited in the present disclosure.

It may be understood that, in the embodiments of the present disclosure, for the encoder side, the number of scale factor candidate lists may be preset; and for the decoder side, the number of scale factor candidate lists may be preset, or may be determined based on list number information transmitted by the encoder side.

Correspondingly, in the embodiments of the present disclosure, since the number of preset scale factor candidate lists is any value, list number information corresponding to at least one scale factor candidate list may be signalled into the bitstream after setting the at least one scale factor candidate list. Correspondingly, at the decoder side, by decoding the bitstream, list number information indicating the number of scale factor candidate lists is determined, and then the number of scale factor candidate lists may be determined based on the list number information, so that the at least one scale factor candidate list may be set.

It should be noted that in the embodiments of the present disclosure, the preset scale factor candidate list may include at least one candidate scale factor. Herein, all of the at least one candidate scale factor are greater than 0.

It may be understood that, in the embodiments of the present disclosure, the number of candidate scale factors included in each preset scale factor candidate list may be any integer greater than 0. For example, the scale factor candidate list includes 4 candidate scale factors, or may include 5 candidate scale factors, which is not specifically limited in the present disclosure.

Correspondingly, in the embodiments of the present disclosure, for different scale factor candidate lists, the number of candidate scale factors included in each scale factor candidate list may be the same or different, which is not specifically limited in the present disclosure.

Exemplarily, in some embodiments, three scale factor candidate lists are preset. Herein, scale factor candidate list 1 includes 4 candidate scale factors, scale factor candidate list 2 includes 7 candidate scale factors, and scale factor candidate list 3 includes 2 candidate scale factors.

It should be noted that in the embodiments of the present disclosure, values of candidate scale factors included in each preset scale factor candidate list may be any value greater than 0, which is not specifically limited in the present disclosure.

Exemplarily, in some embodiments, the scale factor candidate list includes 4 candidate scale factors, and values of the 4 candidate scale factors are 7, 8, 9, and 10, respectively.

Further, in the embodiments of the present disclosure, when determining the scale factor corresponding to the current colour component of the current picture, at least one candidate scale factor in the scale factor candidate list may be first traversed to determine a rate-distortion cost corresponding to the candidate scale factor; then a candidate scale factor with a minimum rate-distortion cost is determined as an optimal scale factor; and finally, the optimal scale factor may be determined as the scale factor corresponding to the current colour component of the current picture.

Further, in the embodiments of the present disclosure, when traversing at least one candidate scale factor in the scale factor candidate list to determine the rate-distortion cost corresponding to the candidate scale factor, for any candidate scale factor in the scale factor candidate list, filter coefficients may be first determined based on the candidate scale factor, and a reconstructed block of the current block is determined based on the candidate scale factor and the filter coefficients; and then the rate-distortion cost corresponding to the candidate scale factor is determined based on the reconstructed block of the current block.

It should be noted that, for a video picture, the video picture may be partitioned into multiple picture blocks, each picture block to-be-encoded may be referred to as a coding block, and the current block herein specifically refers to a current coding block to-be-predicted. Herein, the current block may be a CTU, or even a CU, a PU, etc., which is not limited in any way in the embodiment of the present disclosure.

It should be noted that in the embodiments of the present disclosure, after construction of the scale factor candidate list is completed, for part or all of candidate scale factors in the scale factor candidate list, corresponding filter coefficients may be respectively determined based on each candidate scale factor; and then the candidate scale factor and corresponding filter coefficients are used to perform filtering processing on samples in the current block to obtain a filtered reconstructed block of the current block, so that the rate-distortion cost may be calculated based on the reconstructed block of the current block to obtain a rate-distortion cost corresponding to the candidate scale factor.

It should be noted that in the embodiments of the present disclosure, for the current colour component of the current picture, a scale factor and filter coefficients used in a CCALF filtering process need to be determined. Herein, the scale factor corresponds to the current colour component of the current picture, and the filter coefficients are related to the scale factor.

It may be understood that, in the embodiments of the present disclosure, for the current colour component of the current picture, the determined corresponding scale factor and filter coefficients may be applied to filtering processing for the current colour component.

That is to say, in the embodiments of the present disclosure, when performing CCALF filtering processing on the current colour component of the current picture, a scale factor corresponding to the current colour component of the current picture may be used, that is, each colour component only corresponds to one scale factor. Scale factors corresponding to different colour components may be the same or different, which is not specifically limited in the present disclosure.

Further, in the embodiments of the present disclosure, before determining the filter coefficients based on the candidate scale factor, first filter coefficients corresponding to the current colour component of the current picture may be first determined.

It should be noted that in the embodiments of the present disclosure, first filter coefficients c of samples of the same category may be solved by constructing a Wiener-Hopf equation Ac=B, herein, the solved filter coefficients are all in floating-point type.

Further, in the embodiments of the present disclosure, when determining the filter coefficients based on the candidate scale factor, scaled coefficients may be first determined based on the candidate scale factor and the first filter coefficients; and then the filter coefficients are determined based on the scaled coefficients.

It may be understood that, in the embodiments of the present disclosure, after determining the first filter coefficients corresponding to the current colour component, integerization may be performed on the first filter coefficients to obtain corresponding filter coefficients.

Exemplarily, in some embodiments, it is assumed that cᵢ is a first filter coefficient solved from the Wiener-Hopf equation, scale is a scale factor (any candidate scale factor), and cᵢ′ is a value after scaling. Specifically, the candidate scale factor may be used to perform scaling processing on the first filter coefficients, such as the formula (5) above.

Correspondingly, a fixed value of 7 may be set. After obtaining cᵢ, a table lookup is performed on cᵢ. Through comparison, a value closest to

$${c}_{i}^{′}$$

is selected from {−64, −32, −16, −8, −4, −2, −1, 0, 1, 2, 4, 8, 16, 32, 64} as an integerized coefficient

$${c}_{i}^{f} .$$

That is, the finally determined integerized coefficient

$${c}_{i}^{f}$$

may be one of {−64, −32, −16, −8, −4, −2, −1, 0, 1, 2, 4, 8, 16, 32, 64}. Herein, after determining the filter coefficients, the filter coefficients may be signalled into the bitstream.

It should be noted that in the embodiments of the present disclosure, when signalling the filter coefficients into the bitstream for transmission to the decoder side, 4 bits may be used to represent the filter coefficients. Herein, 1 bit is used to determine a sign of the filter coefficients, and 3 bits are used to determine values of the filter coefficients.

Exemplarily, in some embodiments, a value of a most significant bit may be used to determine the sign of the filter coefficients. For example, 1 indicates that the sign is negative, 0 indicates that the sign is positive. The other 3 bits are used to determine the value of the filter coefficients. For example, −32 may be represented as 1101 by using 4 bits, and 32 may be represented as 0101 by using 4 bits.

That is, in the embodiments of the present disclosure, the filter coefficients transmitted to the decoder side may be filter coefficients subjected to integerization processing. Specifically, at the encoder side, a scale factor may be selected and used to scale solved floating-point filter coefficients, and then the integerization processing is performed on the scaled filter coefficients to obtain integerized filter coefficients.

It should be noted that in the embodiments of the present disclosure, after determining the filter coefficients based on the candidate scale factor, a reconstructed block of the current block may be further determined based on the candidate scale factor and the filter coefficients. Herein, when determining the reconstructed block of the current block based on the candidate scale factor and the filter coefficients, for a current sample in the current block, a filtered reconstructed value of the current colour component of the current sample may be determined based on a luma reconstructed value of a reference sample corresponding to the current sample, a luma reconstructed value of the current sample, a reconstructed value of the current colour component of the current sample, the candidate scale factor and the filter coefficients; and then the reconstructed block of the current block may be determined based on the filtered reconstructed value of the current colour component of the current sample.

It should be noted that in the embodiments of the present disclosure, after determining the candidate scale factor and the filter coefficients corresponding to the current colour component, for any sample in the current block, filtering processing may be further performed on a reconstructed value of the current colour component of the sample in combination with a luma reconstructed value of a reference sample and a luma reconstructed value of the sample; and finally, a filtered reconstructed value of the current colour component of the sample is determined. Part or all of the samples in the current block are sequentially traversed and filtered reconstructed values of the current colour component of the part or all of the samples are obtained, so that the reconstructed block corresponding to the current colour component of the current block may be determined.

For example, in some embodiments, based on the above formula (6), for the current sample, filtering processing is performed through the reconstructed value (recC) of the current colour component of the current sample, a luma reconstructed value (recY(i)) of a reference sample i, a luma reconstructed value (recY(x)) of the current sample, the scale factor (scale) of the current colour component, and the filter coefficients

$${c}_{i}^{f} ,$$

to determine the filtered reconstructed value (recC′) of the current colour component of the current sample.

It should be noted that, in the embodiment of the present disclosure, when determining the reconstructed block of the current block based on the filtered reconstructed value of the current colour component of the current sample, for a sample subjected to the filtering processing, the filtered reconstructed value may be written into the reconstructed block, and for a sample not subjected to the filtering processing, a reconstructed value of the sample may be directly written into the reconstructed block.

That is, in the embodiment of the present disclosure, it may be selected to perform filtering processing on all or part of the samples of the current block. Herein, for a sample requiring filtering, the filtering processing is performed on this sample and then the filtered sample is written into a reconstructed picture; while for a sample not requiring filtering, this sample is directly written into the reconstructed picture.

It should be noted that, in the embodiment of the present disclosure, after the filtering of the current colour component of the current block is completed, the rate-distortion cost corresponding to the candidate scale factor may be further determined based on the reconstruction block of the current block. Herein, the rate-distortion cost corresponding to the candidate scale factor may consist of two parts: one part is a filtered picture distortion, and the other part is a bit cost required for performing entropy coding on syntax elements.

Exemplarily, in some embodiments, assuming that the rate-distortion cost (RD Cost) based on the candidate scale factor scaleeᵢ is Jᵢ, the corresponding filtered picture distortion is Dᵢ, and the bit cost required for performing entropy encoding on the corresponding syntax element is Rᵢ, the rate-distortion cost Jᵢ may be calculated through the following formula:

Jᵢ=Dᵢ+λRᵢ (7)

Herein, λ is the Lagrange multiplier.

It may be understood that, in the embodiments of the present disclosure, after traversing at least one candidate scale factor in a scale factor candidate list according to the method described above to determine a respective rate-distortion cost corresponding to each of the at least one candidate scale factor, a candidate scale factor with a minimum rate-distortion cost may be selected as an optimal scale factor scale_{best}, and then, the optimal scale factor may be determined as the scale factor corresponding to the current colour component of the current picture.

Further, in the embodiments of the present disclosure, when determining the scale factor corresponding to the current colour component of the current picture, a scale factor corresponding to the current colour component of a picture (which is filtered by using a CCALF) prior to the current picture may be determined as the scale factor corresponding to the current colour component.

That is, in the embodiments of the present disclosure, at an encoder side, a scale factor of the same colour component of a previous picture filtered using the CCALF may also be reused, that is, the scale factor of the same colour component of the previous picture filtered using the CCALF is directly determined as the scale factor of the current colour component of the current picture. Herein, the scale factor of the same colour component of the previous picture filtered using the CCALF may be obtained by traversing the scale factor candidate list and searching for a candidate scale factor with a minimum rate-distortion cost.

It may be understood that, in the embodiments of the present disclosure, when reusing the scale factor of the same colour component of the previous picture filtered using the CCALF, any previous picture filtered using the CCALF may be selected. For example, the scale factor of the current colour component of the current picture may reuse a scale factor of the same colour component of a previous picture (which is filtered using the CCALF) of the current picture, or may reuse a scale factor of the same colour component of a third picture (which is filtered using the CCALF) prior to the current picture, which is not specifically limited in the present disclosure.

It should be noted that in the embodiments of the present disclosure, in a process of traversing the scale factor candidate list, for any candidate scale factor, since operations such as filter coefficient updating, decision-making on whether a CTU (current block) uses the CCALF to perform filtering, and update of a filter category used by the CTU further need to be performed based on the candidate scale factor, multiple rounds of iterative calculation may exist in a process of determining the optimal scale factor in the scale factor candidate list.

Further, in the embodiments of the present disclosure, after determining the scale factor corresponding to the current colour component of the current picture, CCALF parameter information corresponding to the current colour component of the current picture may be further determined based on the scale factor. Herein, the CCALF parameter information may be parameter information related to CCALF filtering processing.

It should be noted that in the embodiments of the present disclosure, an APS unit corresponding to the current picture may include the CCALF parameter information corresponding to the current colour component of the current picture. Herein, the CCALF parameter information may be used for the CCALF filtering processing of the current colour component of the current picture.

That is, in the embodiments of the present disclosure, the APS unit corresponding to the current picture may include the parameter information (i.e., the CCALF parameter information) related to the CCALF filtering processing, and the CCALF filtering processing on the current colour component of the current picture may be completed through the CCALF parameter information.

Exemplarily, in some embodiments, the CCALF parameter information may include at least one or more of the following: an index in a candidate list (first scale factor information), the number of filter groups, filter sorting, filter coefficients (filtering coefficients), whether a CTU uses the CCALF (second identification information), and a filter category used by the CTU.

Further, in the embodiments of the present disclosure, when determining the scale factor corresponding to the current colour component of the current picture, the scale factor corresponding to the current colour component may be directly determined.

That is, in the embodiments of the present disclosure, rate-distortion optimization (RDO) may also not be performed to select the optimal scale factor. Instead, the scale factor corresponding to the current colour component may be directly specified, corresponding CCALF parameter information is obtained based on the scale factor, and then the scale factor and the corresponding CCALF parameter information are signalled into a bitstream.

Further, in the embodiments of the present disclosure, when determining the scale factor corresponding to the current colour component of the current picture, the optimal scale factor may be first determined from the scale factor candidate list; and then the optimal scale factor is determined as the scale factor corresponding to the current colour component of the current picture.

That is, in the embodiments of the present disclosure, rate-distortion optimization (RDO) may also not be performed to select the optimal scale factor. Instead, the optimal scale factor is directly determined in the scale factor candidate list, that is, the scale factor corresponding to the current colour component is directly specified in the scale factor candidate list.

It should be noted that in the embodiments of the present disclosure, when determining the scale factor corresponding to the current colour component of the current picture, an adaptive scale factor may be used only in part of the iterations for obtaining the CCALF parameter information. An optimal filter scale factor and corresponding CCALF parameter information are selected through rate-distortion optimization (RDO), and then the scale factor and the corresponding CCALF parameter information are signalled into a bitstream.

It should be noted that in the embodiments of the present disclosure, when determining the scale factor corresponding to the current colour component of the current picture, during the iterative process for obtaining the CCALF parameter information, all adaptive scale factors are traversed in each round of iteration. After all rounds of iterations are completed, an optimal scale factor is selected through rate-distortion optimization (RDO), and corresponding CCALF parameter information is obtained based on the scale factor, and then the scale factor and the corresponding CCALF parameter information are signalled into a bitstream.

It can be seen that, in the embodiments of the present disclosure, if the CCALF is used to perform filtering on the current colour component of the current picture, information such as whether a CTU uses the CCALF (second identification information) and a filter category used by the CTU may be signalled into the bitstream. If a new filter group is used, information (such as an index in a candidate list of a scale factor obtained based on the optimal scale factor; the number of filter groups; filter sorting; and filter coefficients) is signalled together into the bitstream for transmission to a decoder side.

Further, in the embodiments of the present disclosure, after determining the scale factor corresponding to the current colour component, first scale factor information corresponding to the current colour component may be further determined based on the scale factor corresponding to the current colour component; and then the first scale factor information is signalled into the bitstream.

It should be noted that in the embodiments of the present disclosure, the first scale factor information may be used to determine the scale factor corresponding to the current colour component. Herein, the first scale factor information may include any one of the following: an index value of the scale factor, a value of the scale factor, and a relevant value of the scale factor.

Further, in the embodiments of the present disclosure, when determining the first scale factor information corresponding to the current colour component based on the scale factor corresponding to the current colour component, the first scale factor information may be set based on the scale factor corresponding to the current colour component and the scale factor candidate list.

It should be noted that in the embodiments of the present disclosure, if the first scale factor information is the index value of the scale factor corresponding to the current colour component, the index value of the scale factor may be set based on a candidate scale factor corresponding to the current colour component in the scale factor candidate list. Correspondingly, a candidate scale factor indicated by the index value of the scale factor in the scale factor candidate list is the scale factor corresponding to the current colour component.

That is to say, in the embodiments of the present disclosure, when the first scale factor information is the index value of the scale factor corresponding to the current colour component, a corresponding scale factor may be determined in a preset scale factor candidate list based on the index value.

Exemplarily, in some embodiments, Table 2 is a possible form of a scale factor candidate list. Herein, the scale factor candidate list includes 4 candidate scale factors, which are 7, 8, 9 and 10, respectively. If the candidate scale factor 9 is determined as the scale factor corresponding to the current colour component, the first scale factor information may be set to an index value 3 of the scale factor.

TABLE 2

| Index value | Candidate scale factor |
|---|---|
| 1 | 7 |
| 2 | 8 |
| 3 | 9 |
| 4 | 10 |

Further, when determining the first scale factor information corresponding to the current colour component based on the scale factor corresponding to the current colour component, the scale factor corresponding to the current colour component may be determined as the first scale factor information.

It should be noted that in the embodiments of the present disclosure, if the first scale factor information is a value of the scale factor corresponding to the current colour component, the scale factor corresponding to the current colour component may be directly determined as the first scale factor information.

Further, when determining the first scale factor information corresponding to the current colour component based on the scale factor corresponding to the current colour component, conversion may be performed based on the scale factor corresponding to the current colour component, to determine the first scale factor information.

It should be noted that in the embodiments of the present disclosure, if the first scale factor information is a relevant value of the scale factor corresponding to the current colour component, conversion may be further performed based on the scale factor corresponding to the current colour component, to obtain the first scale factor information corresponding to the current colour component.

Exemplarily, in some embodiments, after determining the scale factor, during a process of performing conversion based on the scale factor, a numerical operation result between the scale factor and a preset value may be determined as a corresponding scale factor. Herein, the preset value may be any value, which is not specifically limited in the present disclosure. For example, a difference operation may be performed on the scale factor and a value 6 (the preset value), and the difference result is determined as the corresponding first scale factor information.

It may be understood that, in the embodiments of the present disclosure, the relevant value of the scale factor may be a value in another form generated by converting the value of the scale factor.

That is to say, in the embodiments of the present disclosure, the form of the first scale factor information transmitted from the encoder side to the decoder side may be any form. For example, the first scale factor information includes, but is not limited to, an index value of the scale factor, a value of the scale factor, and a relevant value of the scale factor, which is not specifically limited in the present disclosure.

It should be noted that in the embodiments of the present disclosure, at the encoder side, the first scale factor information may be signalled into the bitstream in any manner for transmission to the decoder side. Herein, the encoding of the first scale factor information includes, but is not limited to: fixed-length coding, variable-length coding, or adaptive context coding, etc., which is not specifically limited in the embodiments of the present disclosure.

In operation 302: first identification information is determined based on a rate-distortion cost corresponding to the scale factor, and the first identification information is signalled into the bitstream. Herein, the first identification information is used to indicate whether the CCALF is used to perform filtering processing on the current colour component of the current picture.

In the embodiments of the present disclosure, after determining the scale factor corresponding to the current colour component of the current picture, the encoder may further determine the first identification information based on the rate-distortion cost corresponding to the scale factor, and may signal the first identification information into the bitstream. Herein, the first identification information is used to indicate whether the CCALF is used to perform filtering processing on the current colour component of the current picture.

Further, in the embodiments of the present disclosure, the rate-distortion cost corresponding to the scale factor may include: a first cost value corresponding to an optimal scale factor; and a second cost value corresponding to a scale factor, which corresponds to the current colour component, of a previous picture filtered using the CCALF.

That is to say, in the embodiments of the present disclosure, in a case where CCALF is used to perform filtering processing on the current colour component of the current picture, and if the scale factor of the current colour component of the current picture is obtained by traversing a scale factor candidate list and searching for a candidate scale factor with a minimum rate-distortion cost, the rate-distortion cost corresponding to the scale factor may be the first cost value of the optimal scale factor with the minimum rate-distortion cost; if the scale factor of the current colour component of the current picture reuses a scale factor of the same colour component of a previous picture filtered using the CCALF, the rate-distortion cost corresponding to the scale factor may be the second cost value corresponding to the scale factor, which corresponds to the current colour component, of the previous picture filtered using the CCALF.

Further, in the embodiments of the present disclosure, in a case where CCALF is not used to perform filtering processing on the current colour component of the current picture, a third cost value may be determined. Herein, the third cost value is a rate-distortion cost corresponding to a case where CCALF is not used to perform filtering processing on the current colour component of the current picture.

Further, in the embodiments of the present disclosure, when the third cost value is less than the first cost value and the second cost value, a value of the first identification information is set to a first value, so that the first identification information indicates that CCALF is not used to perform filtering processing on the current colour component of the current picture; and when the third cost value is greater than the first cost value or the second cost value, the value of the first identification information is set to a second value, so that the first identification information indicates that CCALF is used to perform filtering processing on the current colour component of the current picture.

It may be understood that, in the embodiments of the present disclosure, if the first cost value, the second cost value and the third cost value are all equal, the value of the first identification information may be set to the first value or the second value, which is not specifically limited in the present disclosure. For example, the value of the first identification information may be set to the first value, so that the first identification information indicates that CCALF is not used to perform filtering processing on the current colour component of the current picture.

It should be noted that in the embodiments of the present disclosure, the rate-distortion cost based on the optimal scale factor, the distortion when no filtering is performed, and the rate-distortion cost when reusing a filter of the same colour component of a previous picture filtered using the CCALF may be compared, to determine the first identification information. Herein, if the rate-distortion cost based on the optimal scale factor is the minimum, a new filter is used for the current colour component of the current picture; and at this time, a value of the first identification information is set to a second value, so that the first identification information indicates that CCALF is used to perform filtering processing on the current colour component of the current picture. If the distortion when no filtering is performed is the minimum, CCALF filtering is not performed on the current colour component of the current picture; and at this time, the value of the first identification information is set to a first value, so that the first identification information indicates that CCALF is not used to perform filtering processing on the current colour component of the current picture. If the rate-distortion cost when reusing the scale factor and the filter of the same colour component of the previous picture filtered using the CCALF to perform filtering is the minimum, the value of the first identification information may be set to the second value, so that the first identification information indicates that CCALF is used to perform filtering processing on the current colour component of the current picture.

Correspondingly, in the embodiments of the present disclosure, if the filtering is required to be performed on the current colour component of the current picture and a new filter is required to be used, the new filter coefficients and the optimal scale factor are used to perform the filtering on the current colour component of the current picture. If the filtering is performed by reusing the filter of the same colour component of the previous picture filtered using the CCALF, filter coefficients of the reused filter and a corresponding scale factor are used to perform the filtering on the current colour component of the current picture. Herein, if CCALF is used to perform filtering processing on the current colour component of the current picture, and after a sample requiring filtering is filtered, the filtered sample is written into a reconstructed picture; and a sample not requiring filtering is directly written into the reconstructed picture.

Exemplarily, in some embodiments, when the value of the first identification information is the first value, it may be determined that CCALF is not used to perform filtering processing on the current colour component of the current picture.

Exemplarily, in some embodiments, when the value of the first identification information is the second value, it may be determined that CCALF is used to perform filtering processing on the current colour component of the current picture.

It should be noted that in the embodiments of the present disclosure, the first identification information may be used to indicate whether CCALF is used to perform filtering processing on the current colour component of the current picture. In addition, the first value is different from the second value, and the first value and the second value may be in a parameter form or a numerical form. In general, the first identification information may be a parameter written in a PPS, or a parameter written in an SPS; or, the first identification information may also be a flag, which is not limited herein.

It should be further noted that, if the first identification information is a flag, then in a specific example, the first value may be set to 1 and the second value may be set to 0. In another specific example, the first value may also be set to true and the second value may also be set to false. In yet another specific example, the first value may also be set to 0 and the second value may also be set to 1; or the first value may also be set to false and the second value may also be set to true. The first value and the second value in the embodiments of the present disclosure are not limited in any way.

Taking the first value being 1 and the second value being 0 as an example, in the embodiments of the present disclosure, if the value of the first identification information is 1, it may be determined that CCALF is not used to perform filtering processing on the current colour component of the current picture. Otherwise, if the value of the first identification information is 0, it may be determined that CCALF is used to perform filtering processing on the current colour component of the current picture.

Further, in the embodiments of the present disclosure, when the optimal scale factor is used, a fourth cost value corresponding to a current block is determined; when a scale factor, which corresponds to the current colour component, of a picture filtered using the CCALF prior to the current picture is reused, a fifth cost value corresponding to the current block is determined; when CCALF is not used to perform filtering processing on the current colour component of the current picture, a sixth cost value corresponding to the current block is determined; and the second identification information is determined based on the fourth cost value, the fifth cost value and the sixth cost value, and the second identification information is signalled into the bitstream.

It should be noted that in the embodiments of the present disclosure, when determining the second identification information based on the fourth cost value, the fifth cost value and the sixth cost value, and when the sixth cost value is less than the fourth cost value and the fifth cost value, a value of the second identification information is set to a third value, so that the second identification information indicates that CCALF is not used to perform filtering processing on the current colour component of the current block; and when the sixth cost value is greater than the fourth cost value or the fifth cost value, the value of the second identification information is set to a fourth value, so that the second identification information indicates that CCALF is used to perform filtering processing on the current colour component of the current block.

It may be understood that, in the embodiments of the present disclosure, if the fourth cost value, the fifth cost value, and the sixth cost value are all equal, the value of the second identification information may be set to the third value or the fourth value, which is not specifically limited in the present disclosure. For example, the value of the second identification information may be set to the third value, so that the second identification information indicates that CCALF is not used to perform filtering processing on the current colour component of the current block.

It may be understood that, in the embodiments of the present disclosure, for a current block, the rate-distortion cost based on the optimal scale factor, the distortion when no filtering is performed, and the rate-distortion cost when reusing a filter of the same colour component of a previous picture filtered using the CCALF may be compared, to determine the second identification information. Herein, if the rate-distortion cost based on the optimal scale factor is the minimum, a new filter is used for a current colour component of the current block; and at this time, a value of the second identification information is set to a fourth value, so that the second identification information indicates that CCALF is used to perform filtering processing on the current colour component of the current block. If the distortion when no filtering is performed is the minimum, CCALF filtering is not performed on the current colour component of the current block; and at this time, the value of the second identification information is set to a third value, so that the second identification information indicates that CCALF is not used to perform filtering processing on the current colour component of the current block. If the rate-distortion cost when reusing the scale factor and the filter of the same colour component of the previous picture filtered using the CCALF to perform filtering is the minimum, the value of the second identification information may be set to the fourth value, so that the second identification information indicates that CCALF is used to perform filtering processing on the current colour component of the current block.

Correspondingly, in the embodiments of the present disclosure, if the filtering is required to be performed on the current colour component of the current block and a new filter is required to be used, the new filter coefficients and the optimal scale factor are used to perform the filtering on the current colour component of the current block. If the filtering is performed by reusing the filter of the same colour component of the previous picture filtered using the CCALF, filter coefficients of the reused filter and a corresponding scale factor are used to perform the filtering on the current colour component of the current block. Herein, if CCALF is used to perform filtering processing on the current colour component of the current block, a sample requiring filtering is filtered, and then the filtered sample is written into a reconstructed block; and a sample not requiring filtering is directly written into the reconstructed block.

Exemplarily, in some embodiments, if the value of the second identification information is the third value, it may be determined that CCALF is not used to perform filtering processing on the current colour component of the current block.

Exemplarily, in some embodiments, if the value of the second identification information is the fourth value, it may be determined that CCALF is used to perform filtering processing on the current colour component of the current block.

It should be noted that in the embodiments of the present disclosure, the second identification information may be used to indicate whether CCALF is used to perform filtering processing on the current colour component of the current block. In addition, the third value is different from the fourth value, and the third value and the fourth value may be in a parameter form or a numerical form. In general, the second identification information may be a parameter written in an APS unit corresponding to the current picture.

Exemplarily, in some embodiments, the third value may be set to 1, and the fourth value may be set to 0. In another specific example, the third value may also be set to true, and the fourth value may also be set to false. In yet another specific example, the third value may also be set to 0, and the fourth value may also be set to 1; or the third value may also be set to false, and the fourth value may also be set to true. The third value and the fourth value in the embodiments of the present disclosure are not limited in any way.

Taking the third value being 1 and the fourth value being 0 as an example, in the embodiments of the present disclosure, if the value of the second identification information is 1, it may be determined that CCALF is not used to perform filtering processing on the current colour component of the current block. Otherwise, if the value of the first identification information is 0, it may be determined that CCALF is used to perform filtering processing on the current colour component of the current block.

Further, in the embodiments of the present disclosure, in response to determining that CCALF is used to perform filtering processing on the current colour component of the current picture, an APS unit corresponding to the current picture may be determined; then an APS index corresponding to the current picture may be determined based on the APS unit; and finally, the APS unit and the APS index may be signalled into the bitstream.

It should be noted that in the embodiments of the present disclosure, the APS index corresponding to the current picture may be used to indicate the APS unit corresponding to the current picture. Herein, the APS index corresponding to the current picture may be an APS ID corresponding to the current picture.

That is to say, in the embodiments of the present disclosure, if CCALF is used to perform filtering processing on the current colour component of the current picture, the APS unit corresponding to the current picture may be further determined, and then the APS ID corresponding to the current picture is determined based on the APS unit corresponding to the current picture.

It should be noted that in the embodiments of the present disclosure, if the scale factor corresponding to the current colour component of the current picture reuses a scale factor, which corresponds to the current colour component, of a picture filtered using the CCALF prior to the current picture, when determining the APS unit corresponding to the current picture, the APS unit of the previous picture filtered using CCALF that is reused may be directly used as the APS unit corresponding to the current picture; or, the APS ID of the previous picture filtered using CCALF that is reused may also be directly used as the APS ID corresponding to the current picture.

Further, in the embodiments of the present disclosure, the APS unit corresponding to the current picture includes at least one or more of following: the second identification information, filter coefficients corresponding to the current colour component of the current picture, and first scale factor information corresponding to the current colour component of the current picture.

That is to say, in the embodiments of the present disclosure, the encoder side may signal the APS unit corresponding to the current picture into the bitstream for transmission to the decoder side, so that the decoder side can determine the APS unit corresponding to the current picture by decoding the bitstream, and determine the first scale factor information corresponding to the current colour component, the filter coefficients corresponding to the current colour component and the second identification information by parsing the APS unit.

In summary, through the encoding method proposed in the above operation 301 to operation 302, a filter precision adaptive method is designed. In the CCALF technology, the optimal scale factor is adaptively selected for colour components within one picture, herein, all filters of the same colour component within the same picture use the same scale factor, which can reduce bit cost. In addition, under the framework of the CCALF algorithm, the global optimal solution can be further approached, and the coding performance can be improved.

Exemplarily, in some embodiments, taking a syntax and semantics level in ECM as an example, modifications made by the encoding method proposed in the embodiments of the present disclosure at the syntax and semantics level are described:

| | |
|---|---|
| if ( alf_cross_component_cb_filter_signal_flag ) { | |
| alf_cross_component_cb_filters_signalled_minus1 | ue(v) |
| alf_cross_component_cb_coeff_prec_idx | u(2) |
| for( k = 0; k < (alf_cross_component_cb_filters_signalled_minus1+1); k++ ) | |
| { | |
| for ( j = 0; j < 24; j++ ) { | |
| alf_cc_cb_mapped_coeff_abs [ k ][ j ] | u(3) |
| if ( alf_cc_cb_mapped_coeff_abs [ k ][ j ] != 0) | |
| alf_cc_cb_coeff_sign [ k ][ j ] | u(1) |
| } | |
| } | |
| } | |
| if ( alf_cross_component_cr_filter_signal_flag ) { | |
| alf_cross_component_cr_filters_signalled_minus1 | ue(v) |
| alf_cross_component_cr_coeff_prec_idx | u(2) |
| for( k = 0; k < (alf_cross_component_cr_filters_signalled_minus1+1); k++ ) | |
| { | |
| for ( j = 0; j < 24; j++ ) { | |
| alf_cc_cr_mapped_coeff_abs [ k ][ j ] | u(3) |
| if ( alf_cc_cr_mapped_coeff_abs [ k ][ j ] != 0) | |
| alf_cc_cr_coeff_sign [ k ][ j ] | u(1) |
| } | |
| } | |
| } | |

Here, alf_cross_component_cb_coeff_prec_idx indicates an index (an index value of a scale factor) of an optimal scale factor used by a chroma U component in a candidate list (a scale factor candidate list). In a current implementation, the number N of candidate scale factors in the scale factor candidate list is set to 4, so only 2 bits are required to encode the index. alf_cross_component_cr_coeff_prec_idx is an index of an optimal scale factor of a chroma V component.

Exemplarily, in some embodiments, implementation is performed on reference software ECM-10.0, the number N of candidate scale factors in a scale factor candidate list is set to 4, and the scale factor candidate list is {7, 8, 9, 10}. Under an All Intra (AI) configuration condition, testing is performed on part of test sequences required by ECM, and average changes of BD-rate on Y, U, and V components under Classes B, C, and D are 0.00%, −0.22%, and −0.33%, respectively. Under a Random Access configuration condition, testing is performed on part of the test sequences required by ECM, and average changes of BD-rates on Y, U, and V components under Classes B, C, and D are 0.00%,-0.36%, and −0.48%, respectively. It can be seen that data of the above test results indicates that the encoding method proposed in the embodiments of the present disclosure improves encoding performance.

That is, the encoding method proposed by the embodiment of the present disclosure allows conventional CCALF to obtain additional performance gains in a case where complexities at an encoder side and a decoder side are almost unchanged.

Herein, Class is a video class, Sequence is a specific test sequence, and Y, Cb, and Cr indicate performances of three components of video luma and chroma. Values in the tables are BD-rate. BD-rate is a way to measure algorithm performance, indicating the change in bit rate and Peak Signal to Noise Ratio (PSNR) (or SSIM) of a new coding algorithm relative to an original algorithm. An overall negative value indicates that performance is improved, and the larger the absolute value, the greater the performance improvement.

Embodiments of the present disclosure provide an encoding method. At an encoder side, a scale factor corresponding to a current colour component of a current picture is determined; first identification information is determined based on a rate-distortion cost corresponding to the scale factor, and the first identification information is signalled into the bitstream; herein, the first identification information is used to indicate whether CCALF is used to perform filtering processing on the current colour component of the current picture. That is to say, in the embodiments of the present disclosure, the encoder side may adaptively determine the corresponding scale factor for the current colour component of the current picture. At a decoder side, in response to determining that CCALF is used to perform filtering processing on the current colour component of the current picture, the scale factor corresponding to the current colour component of the current picture may be used to perform CCALF filtering processing on the current colour component, herein, each filter for the current colour component uses the same scale factor, thereby obtaining a more ideal filtering effect and improving coding performance.

Another embodiment of the present disclosure proposes an encoding method. The method is applied to an encoder and is used to perform filtering processing through ALF, and the method for performing encoding processing by the encoder may include following operations 401-402.

In operation 401: a scale factor corresponding to a current colour component of a current picture is determined.

In the embodiments of the present disclosure, the encoder may first determine the scale factor corresponding to the current colour component of the current picture.

Further, in the embodiments of the present disclosure, at least one scale factor candidate list may be preset, and the scale factor candidate list is used to determine the scale factor corresponding to the current colour component.

It should be noted that in the embodiments of the present disclosure, the number of preset scale factor candidate lists may be any integer greater than 0. For example, the number of scale factor candidate lists may be 1 or 3, which is not specifically limited in the present disclosure.

It may be understood that, in the embodiments of the present disclosure, for the encoder side, the number of scale factor candidate lists may be preset; for the decoder side, the number of scale factor candidate lists may be set, or may be determined based on list number information transmitted from the encoder side.

Correspondingly, in the embodiments of the present disclosure, since the number of preset scale factor candidate lists is any value, after setting at least one scale factor candidate list, list number information corresponding to the at least one scale factor candidate list may be further signalled into the bitstream. Correspondingly, at the decoder side, by decoding the bitstream, the list number information indicating the number of scale factor candidate lists may be determined, and then the number of scale factor candidate lists may be determined based on the list number information, so that the at least one scale factor candidate list may be set.

It should be noted that in the embodiments of the present disclosure, the preset scale factor candidate list may include at least one candidate scale factor. Herein, the at least one candidate scale factor is greater than 0.

It may be understood that, in the embodiments of the present disclosure, the number of candidate scale factors included in each preset scale factor candidate list may be any integer greater than 0. For example, the scale factor candidate list includes 4 candidate scale factors, or may include 5 candidate scale factors, which is not specifically limited in the present disclosure.

Correspondingly, in the embodiments of the present disclosure, for different scale factor candidate lists, the number of candidate scale factors included in each scale factor candidate list may be the same or different, which is not specifically limited in the present disclosure. Exemplarily, in some embodiments, 3 scale factor candidate lists are preset. Herein, scale factor candidate list 1 includes 4 candidate scale factors, scale factor candidate list 2 includes 7 candidate scale factors, and scale factor candidate list 3 includes 2 candidate scale factors.

It should be noted that in the embodiments of the present disclosure, a value of each candidate scale factor included in each preset scale factor candidate list may be any value greater than 0, which is not specifically limited in the present disclosure.

Exemplarily, in some embodiments, the scale factor candidate list includes 4 candidate scale factors, and values of the 4 candidate scale factors are 7, 8, 9, and 10, respectively.

Further, in the embodiments of the present disclosure, when determining the scale factor corresponding to the current colour component of the current picture, at least one candidate scale factor in the scale factor candidate list may be traversed first to determine a rate-distortion cost corresponding to the candidate scale factor; then a candidate scale factor with a minimum rate-distortion cost is determined as an optimal scale factor; and finally, the optimal scale factor may be determined as the scale factor corresponding to the current colour component of the current picture.

Further, in the embodiments of the present disclosure, when traversing the at least one candidate scale factor in the scale factor candidate list to determine the rate-distortion cost corresponding to the candidate scale factor, for any candidate scale factor in the scale factor candidate list, filter coefficients may be determined first based on the candidate scale factor, and a reconstructed block of a current block is determined based on the candidate scale factor, the filter coefficients and clipping information; and then the rate-distortion cost corresponding to the candidate scale factor is determined based on the reconstructed block of the current block.

It should be noted that, for a video picture, the video picture may be partitioned into multiple picture blocks, each picture block to-be-encoded may be referred to as a decoding block, and the current block herein specifically refers to a current coding block to-be-predicted. Herein, the current block may be a CTU, or even a CU, a PU, etc., which is not limited in any way in the embodiment of the present disclosure.

It should be noted that in the embodiments of the present disclosure, after construction of the scale factor candidate list is completed, for part or all of candidate scale factors in the scale factor candidate list, corresponding filter coefficients may be respectively determined based on each candidate scale factor; then, the candidate scale factor, the filter coefficients, and the clipping information are used to perform filtering processing on samples in the current block, to obtain a filtered reconstructed block of the current block, so that the rate-distortion cost may be calculated based on the reconstructed block of the current block to obtain a rate-distortion cost corresponding to the candidate scale factor.

It should be noted that in the embodiments of the present disclosure, for the current colour component of the current picture, a scale factor, filter coefficients, and clipping information used in an ALF filtering process need to be determined. Herein, the scale factor corresponds to the current colour component of the current picture, and the filter coefficients are related to the scale factor.

It may be understood that, in the embodiments of the present disclosure, for the current colour component of the current picture, the determined corresponding scale factor, filter coefficients, and clipping information may be applied to filtering processing for the current colour component.

That is to say, in the embodiments of the present disclosure, when performing CCALF filtering processing on the current colour component of the current picture, one scale factor corresponding to the current colour component of the current picture may be used, that is, each colour component only corresponds to one scale factor, and scale factors corresponding to different colour components may be the same or different, which is not specifically limited in the present disclosure.

Further, in the embodiments of the present disclosure, before determining the filter coefficients based on the candidate scale factor, first filter coefficients corresponding to the current colour component of the current picture may be determined first.

It should be noted that in the embodiments of the present disclosure, first filter coefficients c of samples of the same category may be solved by constructing a Wiener-Hopf equation Ac=B, herein, the solved filter coefficients are all in floating-point type.

Further, in the embodiments of the present disclosure, when determining the filter coefficients based on the candidate scale factor, scaled coefficients may be first determined based on the candidate scale factor and the first filter coefficients; and then the filter coefficients are determined based on the scaled coefficients.

It may be understood that, in the embodiments of the present disclosure, after determining the first filter coefficients corresponding to the current colour component, integerization may be performed on the first filter coefficients to obtain corresponding filter coefficients.

Exemplarily, in some embodiments, it is assumed that cᵢ is a first filter coefficient solved from the Wiener-Hopf equation, scale is a scale factor (any candidate scale factor), and cᵢ′ is a value after scaling. Specifically, the candidate scale factor may be used to perform scaling processing on the first filter coefficients, such as the formula (5) above.

Correspondingly, a fixed value of 7 may be set. After obtaining cᵢ, a table lookup is performed on cᵢ. Through comparison, a value closest to

$${c}_{i}^{′}$$

is selected from {−64, −32, −16, −8, −4, −2, −1, 0, 1, 2, 4, 8, 16, 32, 64} as an integerized coefficient

$${c}_{i}^{f} .$$

That is, the finally determined integerized coefficient

$${c}_{i}^{f}$$

may be one of {−64, −32, −16, −8, −4, −2, −1, 0, 1, 2, 4, 8, 16, 32, 64}. Herein, after determining the filter coefficients, the filter coefficients may be signalled into the bitstream.

It should be noted that in the embodiments of the present disclosure, when signalling the filter coefficients into the bitstream for transmission to the decoder side, 4 bits may be used to represent the filter coefficients. Herein, 1 bit is used to determine a sign of the filter coefficients, and 3 bits are used to determine values of the filter coefficients.

Exemplarily, in some embodiments, a value of a most significant bit may be used to determine the sign of the filter coefficients. For example, 1 indicates that the sign is negative, 0 indicates that the sign is positive. The other 3 bits are used to determine the value of the filter coefficients. For example, −32 may be represented as 1101 by using 4 bits, and 32 may be represented as 0101 by using 4 bits.

That is, in the embodiments of the present disclosure, the filter coefficients transmitted to the decoder side may be filter coefficients subjected to integerization processing. Specifically, at the encoder side, a scale factor may be selected and used to scale solved floating-point filter coefficients, and then the integerization processing is performed on the scaled filter coefficients to obtain integerized filter coefficients.

It should be noted that in the embodiments of the present disclosure, after determining filter coefficients based on the candidate scale factor, ALF filtering may be further performed on a current colour component of a current block based on the candidate scale factor, the filter coefficients and clipping information; and finally, a filtered block of the current block is determined, and a corresponding reconstructed block is further determined. Herein, when determining the filtered block of the current block based on the scale factor, the filter coefficients and the clipping information, for a current sample in the current block, a filtered sample value of the current colour component of the current sample is determined based on a reconstructed value of a reference sample corresponding to the current sample, a reconstructed value of the current sample, reference information of the current colour component of the current sample, the scale factor, the filter coefficients, and the clipping information; then, a filtered sample block of the current block may be determined based on the filtered sample value of the current colour component of the current sample, that is, the filtered block of the current block is determined.

It should be noted that in the embodiments of the present disclosure, after determining the filter coefficients, the clipping information and the scale factor corresponding to a current colour component, for any sample in the current block, filtering processing may be further performed on the reconstructed value of the current colour component of the sample in combination with a luma reconstructed value of a reference sample and a luma reconstructed value of the sample; and finally, a filtered reconstructed value of the current colour component of the sample is determined. Part or all of the samples in the current block are sequentially traversed, and filtered reconstructed values of the current colour component of the part or all of the samples are obtained, so that the reconstructed block corresponding to the current colour component of the current block may be determined.

It should be noted that in the embodiments of the present disclosure, when determining the reconstructed block of the current block based on the filtered reconstructed value of the current colour component of the current sample, for a sample subjected to the filtering processing, the filtered reconstructed value may be written into the reconstructed block; and for a sample not subjected to the filtering processing, a reconstructed value of the sample may be directly written into the reconstructed block.

That is to say, in the embodiments of the present disclosure, it may be selected to perform filtering processing on all or part of the samples of the current block. Herein, for a sample requiring filtering, the filtering processing is performed on this sample and then the filtered sample is written into a reconstructed picture; while for a sample not requiring filtering, this sample is directly written into the reconstructed picture.

It should be noted that in the embodiments of the present disclosure, after the filtering of the current colour component of the current block is completed, the rate-distortion cost corresponding to the candidate scale factor may be further determined based on the reconstruction block of the current block. Herein, the rate-distortion cost corresponding to the candidate scale factor may consist of two parts: one part is a filtered picture distortion, and the other part is a bit cost required for performing entropy coding on syntax elements.

Exemplarily, in some embodiments, assuming that the rate-distortion cost (RD Cost) based on the candidate scale factor scaleᵢ is Jᵢ, the corresponding filtered picture distortion is Dᵢ, and the bit cost required for performing entropy encoding on the corresponding syntax element is Rᵢ, the rate-distortion cost Jᵢ may be calculated through the following formula:

Jᵢ=Dᵢ+λRᵢ (7)

Herein, λ is the Lagrange multiplier.

It may be understood that, in the embodiments of the present disclosure, after traversing at least one candidate scale factor in a scale factor candidate list according to the method described above to determine a respective rate-distortion cost corresponding to each of the at least one candidate scale factor, a candidate scale factor with a minimum rate-distortion cost may be selected as an optimal scale factor scale_{best}, and then, the optimal scale factor may be determined as the scale factor corresponding to the current colour component of the current picture.

Further, in the embodiments of the present disclosure, when determining the scale factor corresponding to the current colour component of the current picture, a scale factor, which corresponds to the current colour component, of a picture filtered using the ALF prior to the current picture may also be determined as the scale factor corresponding to the current colour component.

That is to say, in the embodiments of the present disclosure, at an encoder side, a scale factor of a same colour component of a previous picture filtered using the ALF may also be reused, that is, the scale factor of the same colour component of the previous picture filtered using the ALF is directly determined as the scale factor of the current colour component of the current picture. Herein, the scale factor of the same colour component of the previous picture filtered using the ALF may be obtained by traversing the scale factor candidate list and searching for a candidate scale factor with a minimum rate-distortion cost.

It may be understood that, in the embodiments of the present disclosure, when reusing the scale factor of the same colour component of the previous picture filtered using the ALF, any previous picture using the ALF filtering may be selected for use. For example, the scale factor of the current colour component of the current picture may reuse the scale factor of the same colour component of the picture (which is filtered using the ALF) prior to the current picture, or may reuse a scale factor of the same colour component of a third picture (which is filtered using the ALF) prior to the current picture, which is not specifically limited in the present disclosure.

It should be noted that in the embodiments of the present disclosure, in a process of traversing the scale factor candidate list, for any candidate scale factor, since operations such as filter coefficient updating, decision-making on whether a CTU (current block) uses the ALF to perform filtering, and update of a filter category used by the CTU further need to be performed based on the candidate scale factor, multiple rounds of iterative calculation may exist in a process of determining the optimal scale factor in the scale factor candidate list.

Further, in the embodiments of the present disclosure, after determining the scale factor corresponding to the current colour component of the current picture, ALF parameter information corresponding to the current colour component of the current picture may be further determined based on the scale factor. Herein, the ALF parameter information may be parameter information related to ALF filtering processing.

It should be noted that in the embodiments of the present disclosure, an APS unit corresponding to the current picture may include the ALF parameter information corresponding to the current colour component of the current picture. Herein, the ALF parameter information may be used for the ALF filtering processing of the current colour component of the current picture.

That is to say, in the embodiments of the present disclosure, the APS unit corresponding to the current picture may include the parameter information (i.e., the ALF parameter information) related to the ALF filtering processing, and the ALF filtering processing on the current colour component of the current picture may be completed through the ALF parameter information.

Exemplarily, in some embodiments, the ALF parameter information may include at least one or more of the following: an index in a candidate list (first scale factor information), the number of filter groups, filter sorting, filter coefficients (filtering coefficients), whether a CTU uses the ALF (second identification information), and a filter category used by the CTU.

Further, in the embodiments of the present disclosure, when determining the scale factor corresponding to the current colour component of the current picture, the scale factor corresponding to the current colour component may be directly determined.

That is to say, in the embodiments of the present disclosure, rate-distortion optimization (RDO) may also not be performed to select the optimal scale factor. Instead, the scale factor corresponding to the current colour component may be directly specified, corresponding ALF parameter information is obtained based on the scale factor, and then the scale factor and the corresponding ALF parameter information are signalled into the bitstream.

Further, in the embodiments of the present disclosure, when determining the scale factor corresponding to the current colour component of the current picture, the optimal scale factor may be first determined from the scale factor candidate list; and then the optimal scale factor is determined as the scale factor corresponding to the current colour component of the current picture.

That is, in the embodiments of the present disclosure, rate-distortion optimization (RDO) may also not be performed to select the optimal scale factor. Instead, the optimal scale factor is directly determined in the scale factor candidate list, that is, the scale factor corresponding to the current colour component is directly specified in the scale factor candidate list.

It should be noted that in the embodiments of the present disclosure, when determining the scale factor corresponding to the current colour component of the current picture, an adaptive scale factor may be used only in part of the iterations for obtaining the ALF parameter information. An optimal filter scale factor and corresponding ALF parameter information are selected through rate-distortion optimization (RDO), and then the scale factor and the corresponding ALF parameter information are signalled into a bitstream.

It should be noted that in the embodiments of the present disclosure, when determining the scale factor corresponding to the current colour component of the current picture, during the iterative process for obtaining the ALF parameter information, all adaptive scale factors are traversed in each round of iteration. After all rounds of iterations are completed, an optimal scale factor is selected through rate-distortion optimization (RDO), and corresponding ALF parameter information is obtained based on the scale factor, and then the scale factor and the corresponding ALF parameter information are signalled into a bitstream.

That is to say, in the embodiments of the present disclosure, in response to determining that ALF is used to perform filtering processing on the current colour component of the current picture, the determined ALF parameter information may be signalled into the bitstream for transmission to the decoder side. Herein, the ALF parameter information may include at least: the second identification information, the first scale factor information, the filter coefficients, and the clipping information.

It can be seen that, in the embodiments of the present disclosure, if the ALF is used to perform filtering on the current colour component of the current picture, information such as whether a CTU uses the ALF (second identification information) and a filter category used by the CTU may be signalled into the bitstream. If a new filter group is used, information (such as an index, in a candidate list, of a scale factor obtained based on the optimal scale factor; the number of filter groups; filter sorting; and filter coefficients) is signalled together into the bitstream for transmission to a decoder side.

Further, in the embodiments of the present disclosure, third identification information may also be determined, and the third identification information is signalled into the bitstream.

Herein, the third identification information may be used to determine whether non-fixed filter parameters in the ALF are used to perform filtering processing on the current colour component of the current picture.

Further, in the embodiments of the present disclosure, after determining the scale factor corresponding to the current colour component, first scale factor information corresponding to the current colour component may be further determined based on the scale factor corresponding to the current colour component; and then the first scale factor information is signalled into the bitstream.

It should be noted that in the embodiments of the present disclosure, the first scale factor information may be used to determine the scale factor corresponding to the current colour component. Herein, the first scale factor information may include any one of the following: an index value of the scale factor, a value of the scale factor, and a relevant value of the scale factor.

Further, in the embodiments of the present disclosure, when determining the first scale factor information corresponding to the current colour component based on the scale factor corresponding to the current colour component, the first scale factor information may be set based on the scale factor corresponding to the current colour component and the scale factor candidate list.

It should be noted that in the embodiments of the present disclosure, if the first scale factor information is the index value of the scale factor corresponding to the current colour component, the index value of the scale factor may be set based on a candidate scale factor corresponding to the current colour component in the scale factor candidate list. Correspondingly, a candidate scale factor indicated by the index value of the scale factor in the scale factor candidate list is the scale factor corresponding to the current colour component.

That is to say, in the embodiments of the present disclosure, when the first scale factor information is the index value of the scale factor corresponding to the current colour component, a corresponding scale factor may be determined in a preset scale factor candidate list based on the index value.

Further, when determining the first scale factor information corresponding to the current colour component based on the scale factor corresponding to the current colour component, the scale factor corresponding to the current colour component may be determined as the first scale factor information.

It should be noted that in the embodiments of the present disclosure, if the first scale factor information is a value of the scale factor corresponding to the current colour component, the scale factor corresponding to the current colour component may be directly determined as the first scale factor information.

Further, when determining the first scale factor information corresponding to the current colour component based on the scale factor corresponding to the current colour component, conversion may be performed based on the scale factor corresponding to the current colour component, to determine the first scale factor information.

It should be noted that in the embodiments of the present disclosure, if the first scale factor information is a relevant value of the scale factor corresponding to the current colour component, conversion may be further performed based on the scale factor corresponding to the current colour component, to obtain the first scale factor information corresponding to the current colour component.

Exemplarily, in some embodiments, after determining the scale factor, during a process of performing conversion based on the scale factor, a numerical operation result between the scale factor and a preset value may be determined as a corresponding scale factor. Herein, the preset value may be any value, which is not specifically limited in the present disclosure. For example, a difference operation may be performed on the scale factor and a value 6 (the preset value), and the difference result is determined as the corresponding first scale factor information.

It may be understood that, in the embodiments of the present disclosure, the relevant value of the scale factor may be a value in another form generated by converting the value of the scale factor.

That is to say, in the embodiments of the present disclosure, the form of the first scale factor information transmitted from the encoder side to the decoder side may be any form. For example, the first scale factor information includes, but is not limited to, an index value of the scale factor, a value of the scale factor, and a relevant value of the scale factor, which is not specifically limited in the present disclosure.

It should be noted that in the embodiments of the present disclosure, at the encoder side, the first scale factor information may be signalled into the bitstream in any manner for transmission to the decoder side. Herein, the encoding of the first scale factor information includes, but is not limited to: fixed-length coding, variable-length coding, or adaptive context coding, etc., which is not specifically limited in the embodiments of the present

### DISCLOSURE

In operation 402: first identification information is determined based on a rate-distortion cost corresponding to the scale factor, and the first identification information is signalled into the bitstream. Herein, the first identification information is used to indicate whether the ALF is used to perform filtering processing on the current colour component of the current picture.

In the embodiments of the present disclosure, after determining the scale factor corresponding to the current colour component of the current picture, the encoder may further determine the first identification information based on the rate-distortion cost corresponding to the scale factor, and may signal the first identification information into the bitstream. Herein, the first identification information is used to indicate whether the ALF is used to perform filtering processing on the current colour component of the current picture.

That is to say, in a case where the decoding method proposed in the present disclosure is applied to CCALF, the first identification information may be used to determine whether CCALF is used to perform filtering processing on the current colour component of the current picture; and in a case where the decoding method proposed in the present disclosure is applied to ALF, the first identification information may be used to determine whether ALF is used to perform filtering processing on the current colour component of the current picture.

Further, in the embodiments of the present disclosure, the rate-distortion cost corresponding to the scale factor may include: a first cost value corresponding to an optimal scale factor; and a second cost value corresponding to a scale factor, which corresponds to the current colour component, of a previous picture filtered using the ALF.

That is to say, in the embodiments of the present disclosure, in a case where ALF is used to perform filtering processing on the current colour component of the current picture, and if the scale factor of the current colour component of the current picture is obtained by traversing a scale factor candidate list and searching for a candidate scale factor with a minimum rate-distortion cost, the rate-distortion cost corresponding to the scale factor may be the first cost value of the optimal scale factor with the minimum rate-distortion cost; if the scale factor of the current colour component of the current picture reuses a scale factor of the same colour component of a previous picture filtered using the ALF, the rate-distortion cost corresponding to the scale factor may be the second cost value corresponding to the scale factor, which corresponds to the current colour component, of the previous picture filtered using the ALF.

Further, in the embodiments of the present disclosure, in a case where ALF is not used to perform filtering processing on the current colour component of the current picture, a third cost value may be determined. Herein, the third cost value is a rate-distortion cost corresponding to a case where ALF is not used to perform filtering processing on the current colour component of the current picture.

Further, in the embodiments of the present disclosure, when the third cost value is less than the first cost value and the second cost value, a value of the first identification information is set to a first value, so that the first identification information indicates that ALF is not used to perform filtering processing on the current colour component of the current picture; and when the third cost value is greater than the first cost value or the second cost value, the value of the first identification information is set to a second value, so that the first identification information indicates that ALF is used to perform filtering processing on the current colour component of the current picture.

It may be understood that, in the embodiments of the present disclosure, if the first cost value, the second cost value and the third cost value are all equal, the value of the first identification information may be set to the first value or the second value, which is not specifically limited in the present disclosure. For example, the value of the first identification information may be set to the first value, so that the first identification information indicates that ALF is not used to perform filtering processing on the current colour component of the current picture.

It should be noted that in the embodiments of the present disclosure, the rate-distortion cost based on the optimal scale factor, the distortion when no filtering is performed, and the rate-distortion cost when reusing a filter of the same colour component of a previous picture filtered using the ALF may be compared, to determine the first identification information. Herein, if the rate-distortion cost based on the optimal scale factor is the minimum, a new filter is used for the current colour component of the current picture; and at this time, a value of the first identification information is set to a second value, so that the first identification information indicates that ALF is used to perform filtering processing on the current colour component of the current picture. If the distortion when no filtering is performed is the minimum, ALF filtering is not performed on the current colour component of the current picture; and at this time, the value of the first identification information is set to a first value, so that the first identification information indicates that ALF is not used to perform filtering processing on the current colour component of the current picture. If the rate-distortion cost when reusing the scale factor and the filter of the same colour component of the previous picture filtered using the ALF to perform filtering is the minimum, the value of the first identification information may be set to the second value, so that the first identification information indicates that ALF is used to perform filtering processing on the current colour component of the current picture.

Correspondingly, in the embodiments of the present disclosure, if the filtering is required to be performed on the current colour component of the current picture and a new filter is required to be used, the new filter coefficients and the optimal scale factor are used to perform the filtering on the current colour component of the current picture. If the filtering is performed by reusing the filter of the same colour component of the previous picture filtered using the ALF, filter coefficients of the reused filter and a corresponding scale factor are used to perform the filtering on the current colour component of the current picture. Herein, if ALF is used to perform filtering processing on the current colour component of the current picture, a sample requiring filtering is filtered, and then the filtered sample is written into a reconstructed picture; and a sample not requiring filtering is directly written into the reconstructed picture.

Exemplarily, in some embodiments, when the value of the first identification information is the first value, it may be determined that ALF is not used to perform filtering processing on the current colour component of the current picture.

Exemplarily, in some embodiments, when the value of the first identification information is the second value, it may be determined that ALF is used to perform filtering processing on the current colour component of the current picture.

It should be noted that in the embodiments of the present disclosure, the first identification information may be used to indicate whether ALF is used to perform filtering processing on the current colour component of the current picture. In addition, the first value is different from the second value, and the first value and the second value may be in a parameter form or a numerical form. In general, the first identification information may be a parameter written in a PPS, or a parameter written in an SPS; or, the first identification information may also be a flag, which is not limited herein.

It should be further noted that, if the first identification information is a flag, then in a specific example, the first value may be set to 1 and the second value may be set to 0. In another specific example, the first value may also be set to true and the second value may also be set to false. In yet another specific example, the first value may also be set to 0 and the second value may also be set to 1; or the first value may also be set to false and the second value may also be set to true. The first value and the second value in the embodiments of the present disclosure are not limited in any way.

Taking the first value being 1 and the second value being 0 as an example, in the embodiments of the present disclosure, if the value of the first identification information is 1, it may be determined that ALF is not used to perform filtering processing on the current colour component of the current picture. Otherwise, if the value of the first identification information is 0, it may be determined that ALF is used to perform filtering processing on the current colour component of the current picture.

Further, in the embodiments of the present disclosure, when the optimal scale factor is used, a fourth cost value corresponding to a current block is determined; when a scale factor, which corresponds to the current colour component, of a picture filtered using the ALF prior to the current picture is reused, a fifth cost value corresponding to the current block is determined; when ALF is not used to perform filtering processing on the current colour component of the current picture, a sixth cost value corresponding to the current block is determined; and the second identification information is determined based on the fourth cost value, the fifth cost value and the sixth cost value, and the second identification information is signalled into the bitstream.

It should be noted that in the embodiments of the present disclosure, when determining the second identification information based on the fourth cost value, the fifth cost value and the sixth cost value, and when the sixth cost value is less than the fourth cost value and the fifth cost value, a value of the second identification information is set to the third value, so that the second identification information indicates that ALF is not used to perform filtering processing on the current colour component of the current block; and when the sixth cost value is greater than the fourth cost value or the fifth cost value, the value of the second identification information is set to a fourth value, so that the second identification information indicates that ALF is used to perform filtering processing on the current colour component of the current block.

It may be understood that, in the embodiments of the present disclosure, if the fourth cost value, the fifth cost value, and the sixth cost value are all equal, the value of the second identification information may be set to the third value or the fourth value, which is not specifically limited in the present disclosure. For example, the value of the second identification information may be set to the third value, so that the second identification information indicates that ALF is not used to perform filtering processing on the current colour component of the current block.

It may be understood that, in the embodiments of the present disclosure, for a current block, the rate-distortion cost based on the optimal scale factor, the distortion when no filtering is performed, and the rate-distortion cost when reusing a filter of the same colour component of a previous picture filtered using the ALF may be compared, to determine the second identification information. Herein, if the rate-distortion cost based on the optimal scale factor is the minimum, a new filter is used for a current colour component of the current block; and at this time, a value of the second identification information is set to a fourth value, so that the second identification information indicates that ALF is used to perform filtering processing on the current colour component of the current block. If the distortion when no filtering is performed is the minimum, ALF filtering is not performed on the current colour component of the current block; and at this time, the value of the second identification information is set to a third value, so that the second identification information indicates that ALF is not used to perform filtering processing on the current colour component of the current block. If the rate-distortion cost when reusing the scale factor and the filter of the same colour component of the previous picture filtered using the ALF to perform filtering is the minimum, the value of the second identification information may be set to the fourth value, so that the second identification information indicates that ALF is used to perform filtering processing on the current colour component of the current block.

Correspondingly, in the embodiments of the present disclosure, if the filtering is required to be performed on the current colour component of the current block and a new filter is required to be used, the new filter coefficients and the optimal scale factor are used to perform the filtering on the current colour component of the current block. If the filtering is performed by reusing the filter of the same colour component of the previous picture filtered using the ALF, filter coefficients of the reused filter and a corresponding scale factor are used to perform the filtering on the current colour component of the current block. Herein, if ALF is used to perform filtering processing on the current colour component of the current block, and after a sample requiring filtering is filtered, the filtered sample is written into a reconstructed block; and a sample not requiring filtering is directly written into the reconstructed block.

Exemplarily, in some embodiments, if the value of the second identification information is the third value, it may be determined that ALF is not used to perform filtering processing on the current colour component of the current block.

Exemplarily, in some embodiments, if the value of the second identification information is the fourth value, it may be determined that ALF is used to perform filtering processing on the current colour component of the current block.

It should be noted that in the embodiments of the present disclosure, the second identification information may be used to indicate whether ALF is used to perform filtering processing on the current colour component of the current block. In addition, the third value is different from the fourth value, and the third value and the fourth value may be in a parameter form or a numerical form. In general, the second identification information may be a parameter written in an APS unit corresponding to the current picture.

Exemplarily, in some embodiments, the third value may be set to 1, and the fourth value may be set to 0. In another specific example, the third value may also be set to true, and the fourth value may also be set to false. In yet another specific example, the third value may also be set to 0, and the fourth value may also be set to 1; or the third value may also be set to false, and the fourth value may also be set to true. The third value and the fourth value in the embodiments of the present disclosure are not limited in any way.

Taking the third value being 1 and the fourth value being 0 as an example, in the embodiments of the present disclosure, if the value of the second identification information is 1, it may be determined that ALF is not used to perform filtering processing on the current colour component of the current block. Otherwise, if the value of the first identification information is 0, it may be determined that ALF is used to perform filtering processing on the current colour component of the current block.

Further, in the embodiments of the present disclosure, in response to determining that ALF is used to perform filtering processing on the current colour component of the current picture, an APS unit corresponding to the current picture may be determined; then an APS index corresponding to the current picture may be determined based on the APS unit; and finally, the APS unit and the APS index may be signalled into the bitstream.

It should be noted that in the embodiments of the present disclosure, the APS index corresponding to the current picture may be used to indicate the APS unit corresponding to the current picture. Herein, the APS index corresponding to the current picture may be an APS ID corresponding to the current picture.

That is to say, in the embodiments of the present disclosure, if ALF is used to perform filtering processing on the current colour component of the current picture, the APS unit corresponding to the current picture may be further determined, and then the APS ID corresponding to the current picture is determined based on the APS unit corresponding to the current picture.

It should be noted that in the embodiments of the present disclosure, if the scale factor corresponding to the current colour component of the current picture reuses a scale factor, which corresponds to the current colour component, of a picture filtered using the ALF prior to the current picture, when determining the APS unit corresponding to the current picture, the APS unit of the reused previous picture filtered using ALF may be directly used as the APS unit corresponding to the current picture; or, the APS ID of the reused previous picture filtered using ALF may also be directly used as the APS ID corresponding to the current picture.

Further, in the embodiments of the present disclosure, the APS unit corresponding to the current picture includes at least one or more of following: the second identification information, clipping information and filter coefficients corresponding to the current colour component of the current picture, and first scale factor information corresponding to the current colour component of the current picture.

That is to say, in the embodiments of the present disclosure, the encoder side may signal the APS unit corresponding to the current picture into the bitstream for transmission to the decoder side, so that the decoder side can determine the APS unit corresponding to the current picture by decoding the bitstream, and determine the first scale factor information corresponding to the current colour component, clipping information and the filter coefficients corresponding to the current colour component, and the second identification information by parsing the APS unit.

That is, the encoding method proposed in the present disclosure may be applied to both CCALF and ALF. Herein, the process of iteratively obtaining the ALF parameter information and the ALF filtering process are similar to those of CCALF.

Exemplarily, in some embodiments, at the encoder side, an optimal scale factor is adaptively selected for the luma and colour components of the current picture in ALF based on a preset scale factor list, and the scale factor and the ALF parameter information are signalled into the bitstream for transmission to the decoder side; at the decoder side, the scale factor and the ALF parameter information are determined by decoding the bitstream, and further, the filtering processing is performed by using the scale factor and the ALF parameter information.

Exemplarily, in some embodiments, taking a syntax and semantics level in ECM as an example, the modifications made by the encoding method proposed in the embodiments of the present disclosure at the syntax and semantics level are described as follows:

| | |
|---|---|
| if( alf_luma_filter_signal_flag ) { | |
| alf_luma_clip_flag | u(1) |
| alf_luma_num_filters_signalled_minus1 | ue(v) |
| alf_luma_coeff_prec_idx | u(2) |
| if( alf_luma_num_filters_signalled_minus1 > 0 ) | |
| for( filtIdx = 0; filtIdx < NumAlfFilters; filtIdx++ ) | |
| alf_luma_coeff_delta_idx[ filtIdx ] | u(v) |
| for( sfIdx = 0; sfIdx <= alf_luma_num_filters_signalled_minus1; sfIdx++ ) | |
| for( j = 0; j < 12; j++ ) { | |
| alf_luma_coeff_abs[ sfIdx ][ j ] | ue(v) |
| if( alf_luma_coeff_abs[ sfIdx ][ j ] ) | |
| alf_luma_coeff_sign[ sfIdx ][ j ] | u(1) |
| } | |
| if( alf_luma_clip_flag ) | |
| for( sfIdx = 0; sfIdx <= alf_luma_num_filters_signalled_minus1; sfIdx++ ) | |
| for( j = 0; j < 12; j++ ) | |
| alf_luma_clip_idx[ sfIdx ][ j ] | u(2) |
| } | |
| if( alf_chroma_filter_signal_flag ) { | |
| alf_chroma_clip_flag | u(1) |
| alf_chroma_num_alt_filters_minus1 | ue(v) |
| alf_chroma_coeff_prec_idx | u(2) |
| for( altIdx = 0; altIdx <= alf_chroma_num_alt_filters_minus1; altIdx++ ) { | |
| for( j = 0; j < 6; j++ ) { | |
| alf_chroma_coeff_abs[ altIdx ][ j ] | ue(v) |
| if( alf_chroma_coeff_abs[ altIdx ][ j ] > 0 ) | |
| alf_chroma_coeff_sign[ altIdx ][ j ] | u(1) |
| { | |
| if( alf_chroma_clip_flag ) | |
| for( j = 0; j < 6; j++ ) | |
| alf_chroma_clip_idx[ altIdx ][ j ] | u(2) |
| } | |
| } | |

Embodiments of the present disclosure provide an encoding method. At an encoder side, a scale factor corresponding to a current colour component of a current picture is determined; first identification information is determined based on a rate-distortion cost corresponding to the scale factor, and the first identification information is signalled into the bitstream; herein, the first identification information is used to indicate whether ALF is used to perform filtering processing on the current colour component of the current picture. That is to say, in the embodiments of the present disclosure, the encoder side can adaptively determine the corresponding scale factor for the current colour component of the current picture, At a decoder side, in response to determining that ALF is used to perform filtering processing on the current colour component of the current picture, the scale factor corresponding to the current colour component of the current picture is used to perform ALF filtering processing on the current colour component, herein, each filter of the current colour component uses the same scale factor, thereby achieving a more ideal filtering effect and improving coding performance.

In another embodiment of the present disclosure, based on the same inventive concept as the foregoing embodiments, reference is made to FIG. 10, which shows a schematic diagram of a composition structure of an encoder 100 proposed in an embodiment of the present disclosure. As shown in FIG. 10, the encoder 100 may include: a first determination unit 1001.

The first determination unit 1001 is configured to: determine a scale factor corresponding to a current colour component of a current picture; determine first identification information based on a rate-distortion cost corresponding to the scale factor, and signal the first identification information into the bitstream; herein, the first identification information is used to indicate whether CCALF is used to perform filtering processing on the current colour component of the current picture.

It should be noted that in the embodiments of the present disclosure, the encoder 100 may also be regarded as a data processing mode (or an “entropy encoder”), used to perform encoding processing on values of syntax elements to be encoded.

It may be understood that in the embodiment of the present disclosure, the “unit” may be a part of a circuit, a part of a processor, a part of a program or software, etc. Or, the “unit” may be a module, or may be non-modular. Furthermore, various components in the present embodiment may be integrated into a processing unit, or each unit may physically exist separately, or two or more than two units may be integrated into one unit. The above integrated unit may be implemented in a form of hardware or in a form of software functional module.

If the integrated unit is implemented in a form of software functional module and is not sold or used as an independent product, the integrated unit may be stored in a computer-readable storage medium. Based on such understanding, the technical solutions in the present embodiments, in essence or the part that contributes to the related art, or all or part of the technical solutions may be embodied in the form of a software product. The computer software product is stored in a storage medium, including several instructions to make a computer device (which may be a personal computer, a server, or a network device, etc.) or a processor to perform all or part of the operations of the method described in the present embodiments. The foregoing storage medium includes various media capable of storing program codes, such as a U disk, a mobile hard disk, a Read Only Memory (ROM), a Random Access Memory (RAM), a magnetic disk, or an optical disk, etc.

Therefore, an embodiment of the present disclosure provides a computer-readable storage medium, applied to the encoder 100. The computer-readable storage medium has stored thereon a computer program that when executed by a first processor, implements the method described in any one of the foregoing embodiments.

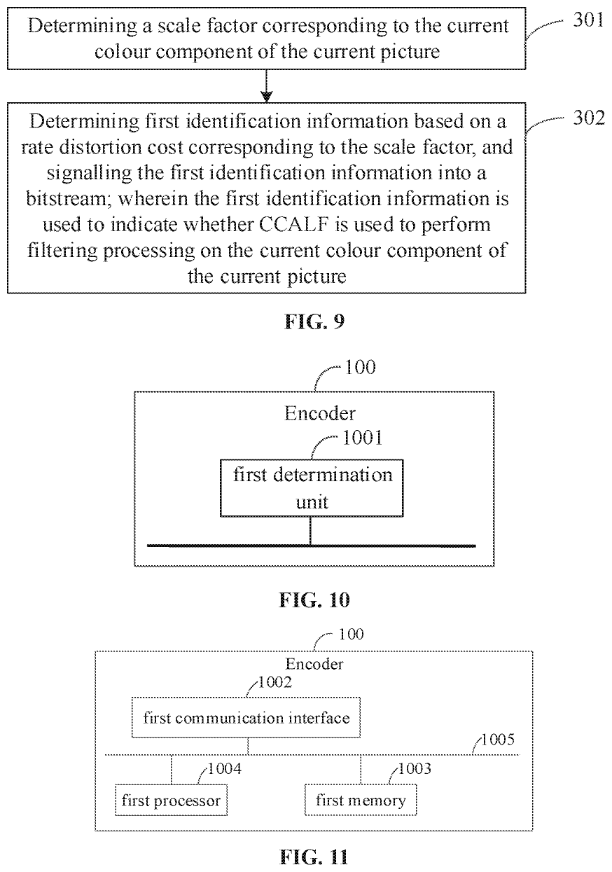

Based on the composition of the encoder 100 and the computer-readable storage medium, with reference to FIG. 11, a schematic diagram of a specific hardware structure of the encoder 100 according to an embodiment of the present disclosure is shown. As shown in FIG. 11, the encoder 100 may include a first communication interface 1002, a first memory 1003, and a first processor 1004; the components are coupled together via a first bus system 1005. It may be understood that the first bus system 1005 is configured to implement connection and communication among these components. In addition to a data bus, the first bus system 1005 further includes a power bus, a control bus, and a status signal bus. However, for the sake of clear explanations, various buses are marked as the first bus system 1005.

The first communication interface 1002 is configured to receive and transmit signals during the process of transmitting and receiving information with other external network elements.

The first memory 1003 is configured to store a computer program executable on the first processor 1004.

The first processor 1004 is configured to: when running the computer program: determine a scale factor corresponding to a current colour component of a current picture; determine first identification information based on a rate-distortion cost corresponding to the scale factor, and signal the first identification information into the bitstream; herein, the first identification information is used to indicate whether CCALF is used to perform filtering processing on the current colour component of the current picture.

It may be understood that the first memory 1003 in the embodiment of the present disclosure may be a volatile memory or a non-volatile memory, or may include both volatile and non-volatile memories. The non-volatile memory may be a ROM, a Programmable ROM (PROM), an Erasable PROM (EPROM), an electrically EPROM (EEPROM), or a flash memory. The volatile memory may be a RAM, which is used as an external cache. Through an exemplary rather than limiting description, many forms of RAMs are available, such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The first memory 1003 of the system and method described in the present disclosure is intended to include, but is not limited to these memories and any other suitable types of memories.

The first processor 1004 may be an integrated circuit chip with a signal processing capability. During implementation, each operation of the above methods may be completed by an integrated logical circuit in a form of hardware in the first processor 1004 or instructions in a form of software. The above first processor 1004 may be a general purpose processor, a Digital Signal Processor (DSP), an Application Specific Integrated Circuit (ASIC), a Field Programmable Gate Array (FPGA) or other programmable logical devices, a discrete gate or transistor logical device, a discrete hardware component, etc. The methods, operations and logic block diagrams disclosed in the embodiments of the present disclosure may be implemented or performed. The general purpose processor may be a microprocessor, or the processor may be any conventional processor, etc. Operations in the methods disclosed according to the embodiments of the present disclosure may be directly embodied as being performed and completed by a hardware decoding processor, or performed and completed by a combination of hardware in the decoding processor and a software module. The software module may be located in a mature storage medium in this field such as a random access memory, a flash memory, a read-only memory, a programmable read-only memory, or an electrically erasable programmable memory, a register, or the like. The storage medium is located in the first memory 1003, and the first processor 1004 reads information in the first memory 1003, and completes the operations in the above methods in combination with the hardware thereof.

It may be understood that these embodiments described in the present disclosure may be implemented in hardware, software, firmware, middleware, microcode or a combination thereof. For implementation in hardware, the processing unit may be implemented in one or more Application Specific Integrated Circuits (ASICs), Digital Signal Processors (DSPs), Digital Signal Processing Devices (DSPDs), Programmable Logic Devices (PLDs), Field-Programmable Gate Arrays (FPGAs), general-purpose processors, controllers, microcontrollers, microprocessors, other electronic units configured to perform functions described in the present disclosure, or combinations thereof. For implementation in software, technologies described in the present disclosure may be implemented by modules (such as processes, functions, etc.) performing the functions described in the present disclosure. Software codes may be stored in a memory and executed by a processor. The memory may be implemented in or out of the processor.

Optionally, as another embodiment, the first processor 1004 is further configured to perform the encoding method of any one of the preceding embodiments when running the computer program.

The present embodiment provides an encoder, the encoder determines a scale factor corresponding to a current colour component of a current picture; determines first identification information based on a rate-distortion cost corresponding to the scale factor, and signals the first identification information into the bitstream; herein, the first identification information is used to indicate whether CCALF is used to perform filtering processing on the current colour component of the current picture. That is to say, in the embodiments of the present disclosure, the encoder side may adaptively determine the corresponding scale factor for the current colour component of the current picture. At the decoder side, in response to determining that CCALF is used to perform filtering processing on the current colour component of the current picture, the scale factor corresponding to the current colour component of the current picture may be used to perform CCALF filtering processing on the current colour component, herein, each filter of the current colour component uses the same scale factor, thereby achieving a more ideal filtering effect and improving coding performance

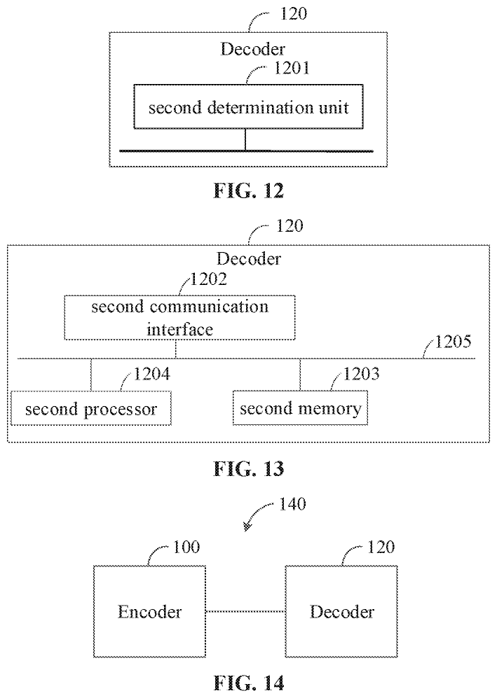

In another embodiment of the present disclosure, based on the same inventive concept as the foregoing embodiments, reference is made to FIG. 12, which shows a schematic diagram of a composition structure of a decoder 120 proposed in an embodiment of the present disclosure. As shown in FIG. 12, the decoder 120 may include a second determination unit 1201.

The second determination unit 1201 is configured to: decode a bitstream to determine first identification information; in response to determining based on the first identification information that CCALF is used to perform filtering processing on a current colour component of a current picture, determine a scale factor and filter coefficients corresponding to the current colour component; and determine a reconstructed block of a current block based on the scale factor and the filter coefficients.

It should be noted that in the embodiments of the present disclosure, the decoder 120 may also be regarded as a data processing mode (or an “entropy decoder”), used to perform decoding processing on values of syntax elements to be decoded.

It may be understood that in the embodiment of the present disclosure, the “unit” may be a part of a circuit, a part of a processor, a part of a program or software, etc. Or, the “unit” may be a module, or may be non-modular. Furthermore, various components in the present embodiment may be integrated into a processing unit, or each unit may physically exist separately, or two or more than two units may be integrated into one unit. The above integrated unit may be implemented in a form of hardware or in a form of software functional module.

If the integrated unit is implemented in a form of software functional module and is not sold or used as an independent product, the integrated unit may be stored in a computer-readable storage medium. Based on such understanding, the embodiment provides a computer-readable storage medium, the computer-readable storage medium is applied to the decoder 120. The computer-readable storage medium has stored thereon a computer program that when executed by a second processor, implements the method described in any one of the foregoing embodiments.

Based on the composition of the decoder 120 and the computer-readable storage medium, with reference to FIG. 13, a schematic diagram of a specific hardware structure of the decoder 120 according to an embodiment of the present disclosure is shown. As shown in FIG. 13, the decoder 120 may include: a second communication interface 1202, a second memory 1203, and a second processor 1204; the components are coupled together via a second bus system 1205. It may be understood that the second bus system 1205 is configured to implement connection and communication among these components. In addition to a data bus, the second bus system 1205 further includes a power bus, a control bus, and a status signal bus. However, for the sake of clear explanations, various buses are marked as the second bus system 324.

The second communication interface 1202 is configured to receive and transmit signals during the process of transmitting and receiving information with other external network elements.

The second memory 1203 is configured to store a computer program executable on the second processor 1204.

The second processor 1204 is configured to, when running the computer program: decode a bitstream to determine first identification information; in response to determining based on the first identification information that CCALF is used to perform filtering processing on a current colour component of a current picture, determine a scale factor and filter coefficients corresponding to the current colour component; and determine a reconstructed block of a current block based on the scale factor and the filter coefficients.

Optionally, as another embodiment, the second processor 1204 is further configured to, when running the computer program, perform the method described in any one of the foregoing embodiments.

It may be understood that a hardware function of the second memory 1203 is similar to that of the first memory 1003, and a hardware function of the second processor 1204 is similar to that of the first processor 1004; details are not described herein again.

The present embodiment provides a decoder. The decoder decodes a bitstream to determine first identification information; in response to determining based on the first identification information that CCALF is used to perform filtering processing on a current colour component of a current picture, determines a scale factor and filter coefficients corresponding to the current colour component; and determines a reconstructed block of a current block based on the scale factor and the filter coefficients. That is to say, in the embodiments of the present disclosure, the encoder side may adaptively determine the corresponding scale factor for the current colour component of the current picture. At a decoder side, in response to determining that CCALF is used to perform filtering processing on the current colour component of the current picture, the scale factor corresponding to the current colour component of the current picture may be used to perform CCALF filtering processing on the current colour component; herein, each filter of the current colour component uses the same scale factor, thereby achieving a more ideal filtering effect and improving coding performance.

In another embodiment of the present disclosure, reference is made to FIG. 14, which shows a schematic diagram of a composition structure of an encoding and decoding system proposed in an embodiment of the present disclosure. As shown in FIG. 14, the encoding and decoding system 140 may include the encoder 100 and the decoder 120.

In the embodiment of the present disclosure, the encoder 100 may be the encoder described in any one of the preceding embodiments, and the decoder 120 may be the decoder described in any one of the preceding embodiments.

Further, an embodiment of the present disclosure further proposes a bitstream. The bitstream is generated by performing bit encoding based on information to-be-encoded; herein, the information to-be-encoded includes at least: first identification information, a scale factor corresponding to a current colour component of a current picture, filter coefficients corresponding to the current colour component of the current picture, second identification information, an APS index corresponding to the current picture, and an APS unit corresponding to the current picture.

It should be noted that in the present disclosure, terms “including”, “include” or any other variants thereof are intended to encompass a non-exclusive inclusion, such that a process, method, article or apparatus including a series of elements includes not only those elements, but also other elements which are not explicitly listed, or elements inherent to such process, method, article or apparatus. Without further limitation, an element defined by a statement “including a . . . ” does not preclude presence of additional identical elements in a process, method, article or apparatus including the element.

The above sequence numbers of the embodiments of the present disclosure are only for the purpose of descriptions, and do not represent advantages and disadvantages of the embodiments.

The methods disclosed in several method embodiments provided in the present disclosure may be arbitrarily combined without conflict, to obtain new method embodiments.

The features disclosed in several product embodiments provided in the present disclosure may be arbitrarily combined without conflict, to obtain new product embodiments.

The features disclosed in several method or device embodiments provided in the present disclosure may be arbitrarily combined without conflict, to obtain new method or device embodiments.

The above descriptions are only specific implementations of the present disclosure, but the scope of protection of the present disclosure is not limited thereto. Variation or replacement easily conceived by any technician skilled in the art within the technical scope disclosed in the present disclosure, should fall within the scope of protection of the present disclosure. Therefore, the scope of protection of the present disclosure should be subject to the scope of protection of the claims.

### INDUSTRIAL PRACTICALITY

The embodiments of the present disclosure provide an encoding method, a decoding method, a bitstream, an encoder, a decoder, and a storage medium. At the decoding side, the bitstream is decoded to determine first identification information; in response to determining based on the first identification information that CCALF is used to perform filtering processing on a current colour component of a current picture, filter coefficients and the scale factor corresponding to the current colour component are determined; and the reconstructed block of the current block is determined based on the scale factor and the filter coefficients. At the encoding side, the scale factor corresponding to a current colour component of a current picture is determined; the first identification information is determined based on the rate-distortion cost corresponding to the scale factor, and the first identification information is signalled into the bitstream, herein, the first identification information is used to indicate whether CCALF is used to perform filtering processing on the current colour component of the current picture. That is, in the embodiments of the present disclosure, the encoding side can adaptively determine the corresponding scale factor for the current colour component of the current picture. At the decoding side, in response to determining that CCALF is used to perform filtering processing on the current colour component of the current picture, the scale factor corresponding to the current colour component of the current picture can be used to perform CCALF filtering processing on the current colour component, where each filter of the current colour component uses the same scale factor, thereby achieving a more ideal filtering effect and improving coding performance.

1. A decoding method, applied to a decoder, the method comprising:
decoding a bitstream to determine first identification information;
in response to determining based on the first identification information that Cross Component Adaptive Loop Filter (CCALF) is used to perform filtering processing on a current colour component of a current picture, determining a scale factor and filter coefficients corresponding to the current colour component; and
determining a reconstructed block of a current block in the current picture based on the scale factor and the filter coefficients.

2. The method of claim 1, wherein determining the scale factor corresponding to the current colour component comprises:
determining first scale factor information corresponding to the current colour component; and
determining the scale factor corresponding to the current colour component based on the first scale factor information.

3. The method of claim 2, wherein determining the scale factor corresponding to the current colour component based on the first scale factor information comprises:
determining the scale factor corresponding to the current colour component based on the first scale factor information and a scale factor candidate list.

4. The method of claim 2, wherein determining the scale factor corresponding to the current colour component based on the first scale factor information comprises:
determining the first scale factor information as the scale factor corresponding to the current colour component.

5. The method of claim 2, wherein determining the scale factor corresponding to the current colour component based on the first scale factor information comprises:
performing conversion based on the first scale factor information, to determine the scale factor corresponding to the current colour component.

6. The method of claim 2, further comprising:
in response to determining based on the first identification information that the CCALF is used to perform filtering processing on the current colour component of the current picture, decoding the bitstream to determine an Adaptive Parameter Set (APS) index corresponding to the current picture;
determining an APS unit corresponding to the current picture based on the APS index; and
determining second identification information based on the APS unit; wherein the second identification information is used to determine whether the CCALF is used to perform filtering processing on the current colour component of the current block.

7. The method of claim 1, wherein determining the reconstructed block of the current block based on the scale factor and the filter coefficients comprises:
for a current sample in the current block, determining a filtered reconstructed value of the current colour component of the current sample based on a luma reconstructed value of a reference sample for the current sample, a luma reconstructed value of the current sample, a reconstructed value of the current colour component of the current sample, the scale factor, and the filter coefficients; and
determining the reconstructed block of the current block based on the filtered reconstructed value of the current colour component of the current sample.

8. The method of claim 1, further comprising:
when a value of the first identification information is a first value, determining that the CCALF is not used to perform filtering processing on the current colour component of the current picture; and
when the value of the first identification information is a second value, determining that the CCALF is used to perform filtering processing on the current colour component of the current picture.

9. The method of claim 3, further comprising:
setting at least one scale factor candidate list.

10. An encoding method, applied to an encoder, the method comprising:
determining a scale factor corresponding to a current colour component of a current picture; and
determining first identification information based on a rate-distortion cost corresponding to the scale factor, and signalling the first identification information into a bitstream; wherein the first identification information is used to indicate whether Cross Component Adaptive Loop Filter (CCALF) is used to perform filtering processing on the current colour component of the current picture.

11. The method of claim 10, further comprising:
setting at least one scale factor candidate list.

12. The method of claim 11, wherein
each of the at least one scale factor candidate list comprises at least one candidate scale factor; wherein the at least one candidate scale factor is greater than 0;
wherein determining the scale factor corresponding to the current colour component of the current picture comprises:
traversing candidate scale factors in the scale factor candidate list to determine rate-distortion costs corresponding to the respective candidate scale factors, comprising:
for any candidate scale factor in the scale factor candidate list, determining filter coefficients based on the candidate scale factor, and determining a reconstructed block of the current block based on the candidate scale factor and the filter coefficients; and
determining a rate-distortion cost corresponding to the candidate scale factor based on the reconstructed block of the current block;
determining a candidate scale factor with a minimum rate-distortion cost as an optimal scale factor; and
determining the optimal scale factor as the scale factor corresponding to the current colour component of the current picture.

13. The method of claim 11, further comprising:
determining first scale factor information corresponding to the current colour component based on the scale factor corresponding to the current colour component; and
signalling the first scale factor information into the bitstream.

14. The method of claim 13, wherein determining the first scale factor information corresponding to the current colour component based on the scale factor corresponding to the current colour component comprises:
setting the first scale factor information based on the scale factor corresponding to the current colour component and the scale factor candidate list.

15. The method of claim 13, wherein determining the first scale factor information corresponding to the current colour component based on the scale factor corresponding to the current colour component comprises:
determining the scale factor corresponding to the current colour component as the first scale factor information.

16. The method of claim 13, wherein determining the first scale factor information corresponding to the current colour component based on the scale factor corresponding to the current colour component comprises:
performing conversion based on the scale factor corresponding to the current colour component, to determine the first scale factor information.

17. The method of claim 12, wherein determining the reconstructed block of the current block based on the candidate scale factor and the filter coefficients comprises:
for a current sample in the current block, determining a filtered reconstructed value of the current colour component of the current sample based on a luma reconstructed value of a reference sample for the current sample, a luma reconstructed value of the current sample, a reconstructed value of the current colour component of the current sample, the candidate scale factor, and the filter coefficients; and
determining the reconstructed block of the current block based on the filtered reconstructed value of the current colour component of the current sample.

18. The method of claim 12, further comprising:
when the CCALF is used to perform filtering processing on the current colour component of the current picture, determining an Adaptive Parameter Set (APS) unit corresponding to the current picture;
determining an APS index corresponding to the current picture based on the APS unit; and
signalling the APS unit and the APS index into the bitstream.

19. A decoder, comprising a processor and a memory configured to store a computer program executable on the processor; wherein when executing the computer program, the processor is configured to:
decode a bitstream to determine first identification information; in response to determining based on the first identification information that Cross Component Adaptive Loop Filter (CCALF) is used to perform filtering processing on a current colour component of a current picture, determine a scale factor and filter coefficients corresponding to the current colour component; and determine a reconstructed block of a current block based on the scale factor and the filter coefficients.

20. A non-transitory computer-readable storage medium, wherein the computer-readable storage medium stores a computer program and a bitstream; and wherein the computer program, when executed by a processor, enables the processor to perform the steps of the encoding method of claim 10 to generate the bitstream.
